(19) United States
(12) Patent Application Publication
(10) Pub. No.: US 2026/0205982 A1
(43) Pub. Date: Jul. 16, 2026

(54) DIGITAL TWIN-ASSISTED VALIDATION FOR POSITIONING MEASUREMENTS AND AI/ML POSITIONING

(71) Applicant: QUALCOMM Incorporated, San Diego, CA (US)

(72) Inventors: Mohammed Ali Mohammed HIRZALLAH, San Diego, CA (US); Xiaoxia ZHANG, San Diego, CA (US); Rajat PRAKASH, San Diego, CA (US)

(21) Appl. No.: 19/017,314

(22) Filed: Jan. 10, 2025

(51) Int. Cl. H04W 64/00; H04B 17/391

(52) U.S. Cl. CPC H04W 64/00; H04B 17/3912; H04B 17/3913

(57) ABSTRACT

A DT consumer transmits, to a digital twin (DT) provider, a first request for a creation of a set of DTs or a network digital twin (NDT) or for an activation of the set of DTs or the NDT for a positioning operation associated with at least one DT consumer. The DT consumer transmits, to the DT provider based on the creation of the set of DTs or the NDT or the activation of the set of DTs or the NDT, a second request to verify data associated with a location of a user equipment (UE) or to validate the data associated with the location of the UE. The DT consumer receives, from the DT provider based on the second request, an indication of a verification of the data associated with the location of the UE or a validation of the data associated with the location of the UE.

### TECHNICAL FIELD

The present disclosure relates generally to communication systems, and more particularly, to wireless communication involving positioning or sensing.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

Some telecommunication standards also provide positioning protocols and techniques that enable mobile network operators to provide high-accuracy location services to their subscribers. For example, 5G NR include various standards for network-based positioning that use signals and features of the 5G network to perform or improve the positioning of a device. There also exists a need for further improvements in these positioning protocols and techniques.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus transmits, to a digital twin (DT) provider, a first request for a creation of a set of DTs or a network digital twin (NDT) or for an activation of the set of DTs or the NDT for a positioning operation associated with at least one DT consumer. The apparatus transmits, to the DT provider based on the creation of the set of DTs or the NDT or the activation of the set of DTs or the NDT, a second request to verify data associated with a location of a user equipment (UE) or to validate the data associated with the location of the UE. The apparatus receives, from the DT provider based on the second request, an indication of a verification of the data associated with the location of the UE or a validation of the data associated with the location of the UE.

In an aspect of the disclosure, a method, a computer-readable medium, and an apparatus are provided. The apparatus receives, from a DT consumer, a first request for a creation of a set of DTs or an NDT or for an activation of the set of DTs or the NDT for a positioning operation associated with at least one DT consumer. The apparatus receives, from the DT consumer based on the creation of the set of DTs or the NDT or the activation of the set of DTs or the NDT, a second request to verify data associated with a location of a user equipment (UE) or to validate the data associated with the location of the UE. The apparatus transmits, to the DT consumer based on the second request, an indication of a verification of the data associated with the location of the UE or a validation of the data associated with the location of the UE.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements (which may also be referred to as “network-based positioning”) in accordance with various aspects of the present disclosure.

FIG. 5 is a diagram illustrating an example radio access technology (RAT)-dependent positioning in accordance with various aspects of the present disclosure.

FIG. 6A is a diagram illustrating an example of direct artificial intelligence (AI) or machine learning (ML) (AI/ML) positioning in accordance with various aspects of the present disclosure.

FIG. 6B is a diagram illustrating an example of AI/ML assisted positioning in accordance with various aspects of the present disclosure.

FIG. 7 is a diagram illustrating an example of UE-based positioning with a UE-side AI/ML model, direct AI/ML or AI/ML assisted positioning in accordance with various aspects of the present disclosure.

FIG. 8A is a diagram illustrating an example of UE-assisted/location management function (LMF)-based positioning with a UE-side AI/ML model, AI/ML assisted positioning in accordance with various aspects of the present disclosure.

FIG. 8B is a diagram illustrating an example of UE-assisted/LMF-based positioning with an LMF-side AI/ML model, direct AI/ML positioning in accordance with various aspects of the present disclosure.

FIG. 9A is a diagram illustrating an example of network node assisted positioning with a base station (gNB)-side AI/ML model, AI/ML assisted positioning in accordance with various aspects of the present disclosure.

FIG. 9B is a diagram illustrating an example of network node assisted positioning with LMF-side AI/ML model, direct AI/ML positioning in accordance with various aspects of the present disclosure.

FIG. 10 is a diagram illustrating an example data monitoring related to AI/ML air interface and AI/ML positioning in accordance with various aspects of the present disclosure.

FIG. 11 is a diagram illustrating an example of digital twin (DT) in accordance with various aspects of the present disclosure.

FIG. 12 is a communication flow illustrating an example of a DT consumer requesting verification/validation of data associated with a location of a UE in accordance with various aspects of the present disclosure.

FIG. 13 is a flowchart of a method of wireless communication.

FIG. 14 is a flowchart of a method of wireless communication.

FIG. 15 is a diagram illustrating an example of a hardware implementation for an example apparatus and/or network entity.

FIG. 16 is a diagram illustrating an example of a hardware implementation for an example network entity.

FIG. 17 is a diagram illustrating an example of a hardware implementation for an example network entity.

FIG. 18 is a flowchart of a method of wireless communication.

FIG. 19 is a diagram illustrating an example of a hardware implementation for an example network entity.

### DETAILED DESCRIPTION

Aspects presented herein may improve the overall performance of positioning by enabling a wireless device (e.g., a user equipment (UE), a base station, or a transmission reception point (TRP), etc.) or a network entity (e.g., a location server, a location management function (LMF), a network data analytics function (NWDAF), an artificial intelligence (AI) or machine learning (ML) (AI/ML) management function, or a sensing management function, etc.) to use a network digital twin (NDT) to verify/validate and/or prune positioning measurements (e.g., for both the AI/ML-based positioning measurements and the non-AI/ML-based positioning measurements), and/or to verify/validate and/or prune AI/ML positioning model/functionality for a UE at a given location. For example, aspects presented herein may enable a wireless device or a network entity to verify/validate AI/ML model(s)/functionali(ties), and decide on whether to employ AI/ML and/or reference signal (RS) resources for future positioning. Aspects presented herein may enable iterative interaction between an NDT consumer (e.g., a wireless device, a network entity, etc.) and an NDT provider, in which the positioning measurements may be pruned and updated based on a coarse/updated positioning (e.g., based a coarse/updated UE location). Aspects presented herein also provide signaling specified between the NDT consumer and the NDT provider to help validate and verify positioning measurements and/or AI/ML models/functionalities.

Some network providers have been scoping involvement of NDT to help optimize and facilitate network services. One key challenge is how to verify and validate on positioning outcomes when provided by devices (e.g., UE or base station, etc.). The problem may also be of more importance when AI/ML is employed to obtain positioning outcomes. Monitoring of AI/ML positioning model/functionality may be demanded frequently in order to verify the validity of the AI/ML positioning model/functionality. As such, NDT may help verifying/validating and/or pruning positioning measurements (both AI/ML or non-AI/ML) or AI/ML positioning model/functionality for a UE at a given location. Another advantage of using the NDT is the ability to decide on whether to employ AI/ML and/or RS resources for future positioning. Aspects presented herein provide signaling between a location management function (LMF), a UE, a base station/gNB, and an NDT to help validate and verify positioning measurements and/or AI/ML models/functionalities. The proposed solution may specify iterative interactions between the LMF, the UE, the base station/gNB, and the NDT, in which the positioning measurements are pruned and updated based on a coarse/updated positioning (e.g., the UE location). Aspects presented herein also provide dedicated signaling procedure between an NDT consumer (e.g., LMF, UE, or gNB/TRP) and an NDT producer entity to verify and validate positioning measurements or AI/ML positioning model/functionality, and also consider dedicated signaling for the DT producer to indicate its positioning capabilities.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

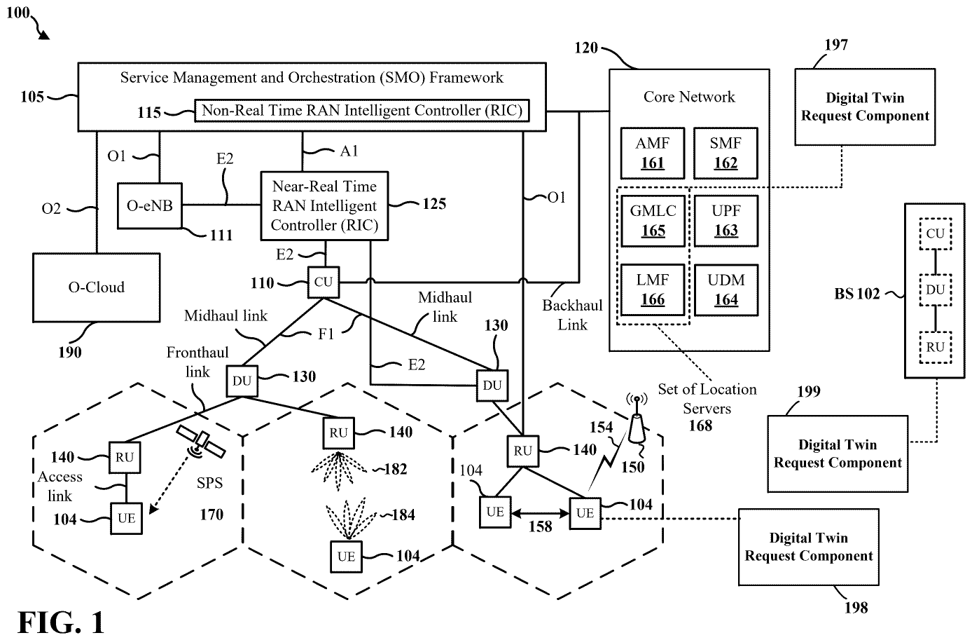

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via dataset collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, the network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smartphone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a digital twin request component 198 that may be configured to transmit, to a DT provider, a first request for a creation of a set of DTs or a network digital twin (NDT) or for an activation of the set of DTs or the NDT for a positioning operation associated with at least one DT consumer; transmit, to the DT provider based on the creation of the set of DTs or the NDT or the activation of the set of DTs or the NDT, a second request to verify data associated with a location of a user equipment (UE) or to validate the data associated with the location of the UE; and receive, from the DT provider based on the second request, an indication of a verification of the data associated with the location of the UE or a validation of the data associated with the location of the UE. In certain aspects, the base station 102 may have a digital twin request component 199 that may be configured to transmit, to a DT provider, a first request for a creation of a set of DTs or an NDT or for an activation of the set of DTs or the NDT for a positioning operation associated with at least one DT consumer; transmit, to the DT provider based on the creation of the set of DTs or the NDT or the activation of the set of DTs or the NDT, a second request to verify data associated with a location of a UE or to validate the data associated with the location of the UE; and receive, from the DT provider based on the second request, an indication of a verification of the data associated with the location of the UE or a validation of the data associated with the location of the UE. In certain aspects, the one or more location servers 168 may have a digital twin request component 197 that may be configured to transmit, to a DT provider, a first request for a creation of a set of DTs or an NDT or for an activation of the set of DTs or the NDT for a positioning operation associated with at least one DT consumer; transmit, to the DT provider based on the creation of the set of DTs or the NDT or the activation of the set of DTs or the NDT, a second request to verify data associated with a location of a UE or to validate the data associated with the location of the UE; and receive, from the DT provider based on the second request, an indication of a verification of the data associated with the location of the UE or a validation of the data associated with the location of the UE. In certain aspects, a DT provider (not shown) may have a digital twin process component 196 that may be configured to receive, from a DT consumer, a first request for a creation of a set of DTs or an NDT or for an activation of the set of DTs or the NDT for a positioning operation associated with at least one DT consumer; receive, from the DT consumer based on the creation of the set of DTs or the NDT or the activation of the set of DTs or the NDT, a second request to verify data associated with a location of a UE or to validate the data associated with the location of the UE; and transmit, to the DT consumer based on the second request, an indication of a verification of the data associated with the location of the UE or a validation of the data associated with the location of the UE.

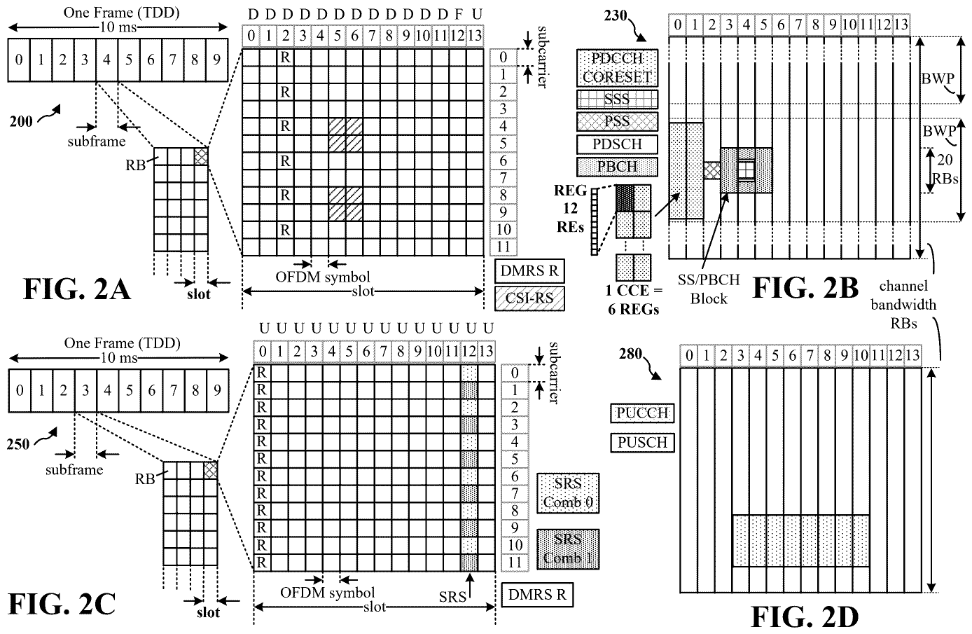

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 2^{μ} *15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

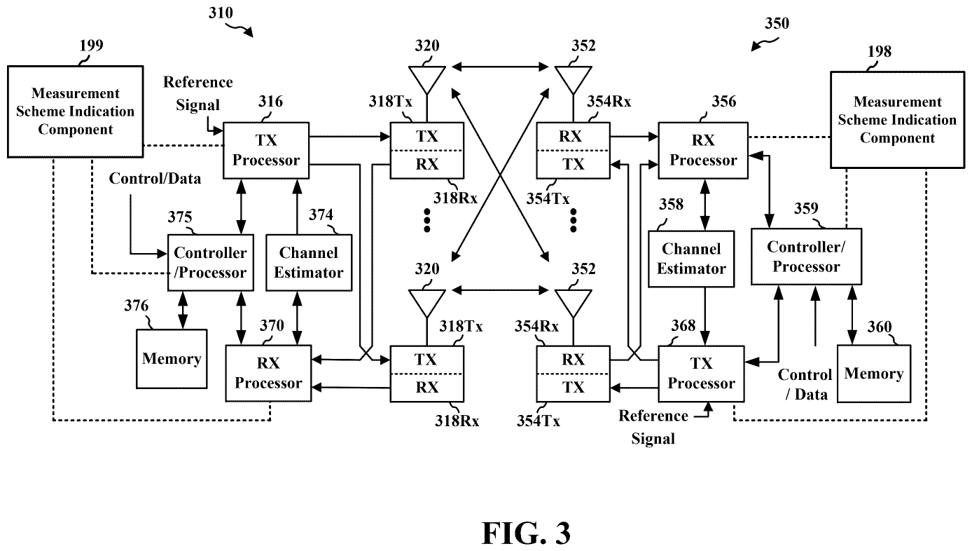

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization. The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the digital twin request component 198 of FIG. 1.

At least one of the TX processor 316, the RX processor 370, and the controller/processor 375 may be configured to perform aspects in connection with the digital twin request component 199 of FIG. 1.

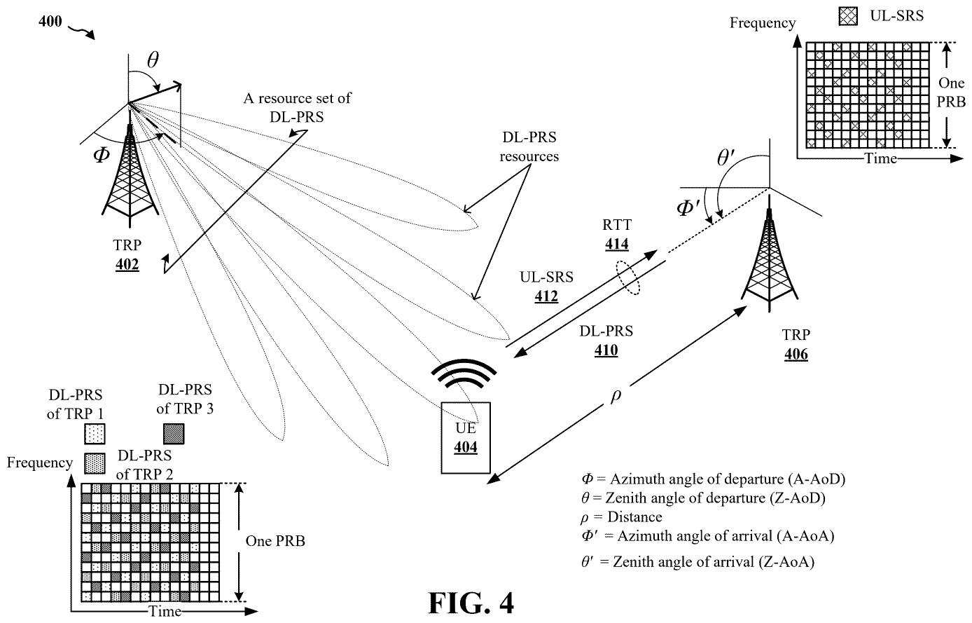

FIG. 4 is a diagram 400 illustrating an example of a UE positioning based on reference signal measurements (which may also be referred to as “network-based positioning”) in accordance with various aspects of the present disclosure. The UE 404 may transmit UL SRS 412 at time T_{SRS_TX} and receive DL positioning reference signals (PRS) (DL PRS) 410 at time T_{PRS_RX}. The TRP 406 may receive the UL SRS 412 at time T_{SRS_RX} and transmit the DL PRS 410 at time T_{PRS_TX}. The UE 404 may receive the DL PRS 410 before transmitting the UL SRS 412, or may transmit the UL SRS 412 before receiving the DL PRS 410. In both cases, a positioning server (e.g., location server(s) 168) or the UE 404 may determine the RTT 414 based on ∥T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL PRS reference signal received power (RSRP) (DL PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL SRS-RSRP at multiple TRPs 402, 406 of uplink signals transmitted from UE 404. The UE 404 measures the UE Rx-Tx time difference measurements (and/or DL PRS-RSRP of the received signals) using assistance data received from the positioning server, and the TRPs 402, 406 measure the gNB Rx-Tx time difference measurements (and/or UL SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

PRSs may be defined for network-based positioning (e.g., NR positioning) to enable UEs to detect and measure more neighbor transmission and reception points (TRPs), where multiple configurations are supported to enable a variety of deployments (e.g., indoor, outdoor, sub-6, mmW, etc.). To support PRS beam operation, beam sweeping may also be configured for PRS. The UL positioning reference signal may be based on sounding reference signals (SRSs) with enhancements/adjustments for positioning purposes. In some examples, UL-PRS may be referred to as “SRS for positioning,” and a new Information Element (IE) may be configured for SRS for positioning in RRC signaling.

DL PRS-RSRP may be defined as the linear average over the power contributions (in [W]) of the resource elements of the antenna port(s) that carry DL PRS reference signals configured for RSRP measurements within the considered measurement frequency bandwidth. In some examples, for FR1, the reference point for the DL PRS-RSRP may be the antenna connector of the UE. For FR2, DL PRS-RSRP may be measured based on the combined signal from antenna elements corresponding to a given receiver branch. For FR1 and FR2, if receiver diversity is in use by the UE, the reported DL PRS-RSRP value may not be lower than the corresponding DL PRS-RSRP of any of the individual receiver branches. Similarly, UL SRS-RSRP may be defined as linear average of the power contributions (in [W]) of the resource elements carrying sounding reference signals (SRS). UL SRS-RSRP may be measured over the configured resource elements within the considered measurement frequency bandwidth in the configured measurement time occasions. In some examples, for FR1, the reference point for the UL SRS-RSRP may be the antenna connector of the base station (e.g., gNB). For FR2, UL SRS-RSRP may be measured based on the combined signal from antenna elements corresponding to a given receiver branch. For FR1 and FR2, if receiver diversity is in use by the base station, the reported UL SRS-RSRP value may not be lower than the corresponding UL SRS-RSRP of any of the individual receiver branches.

PRS-path RSRP (PRS-RSRPP) may be defined as the power of the linear average of the channel response at the i-th path delay of the resource elements that carry DL PRS signal configured for the measurement, where DL PRS-RSRPP for the 1st path delay is the power contribution corresponding to the first detected path in time. In some examples, PRS path Phase measurement may refer to the phase associated with an i-th path of the channel derived using a PRS resource.

DL-AoD positioning may make use of the measured DL PRS-RSRP of downlink signals received from multiple TRPs 402, 406 at the UE 404. The UE 404 measures the DL PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and/or DL PRS-RSRP) of downlink signals received from multiple TRPs 402, 406 at the UE 404. The UE 404 measures the DL RSTD (and/or DL PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and/or UL SRS-RSRP) at multiple TRPs 402, 406 of uplink signals transmitted from UE 404. The TRPs 402, 406 measure the UL-RTOA (and/or UL SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404. For purposes of the present disclosure, a positioning operation in which measurements are provided by a UE to a base station/positioning entity/server to be used in the computation of the UE's position may be described as “UE-assisted,” “UE-assisted positioning,” and/or “UE-assisted position calculation,” while a positioning operation in which a UE measures and computes its own position may be described as “UE-based,” “UE-based positioning,” and/or “UE-based position calculation.”

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS, SSB, SRS, UL-PRS, etc. In addition, the terms “positioning reference signal” and “PRS” may refer to downlink or uplink positioning reference signals, unless otherwise indicated by the context. To further distinguish the type of PRS, a downlink positioning reference signal may be referred to as a “DL PRS,” and an uplink positioning reference signal (e.g., an SRS-for-positioning, PTRS) may be referred to as an “UL-PRS.” In addition, for signals that may be transmitted in both the uplink and downlink (e.g., DMRS, PTRS), the signals may be prepended with “UL” or “DL” to distinguish the direction. For example, “UL-DMRS” may be differentiated from “DL-DMRS.” In addition, the term “location” and “position” may be used interchangeably throughout the specification, which may refer to a particular geographical or a relative place.

For purposes of the present disclosure, “UE Rx−Tx time difference” may be defined as T_{UE-RX}−T_{UE-TX}, where: T_{UE-RX} is the UE received timing of downlink subframe #i from a Transmission Point (TP), defined by the first detected path in time. T_{UE-TX} is the UE transmit timing of uplink subframe #j that is closest in time to the subframe #i received from the TP. Multiple DL PRS or CSI-RS for tracking resources, as instructed by higher layers, can be used to determine the start of one subframe of the first arrival path of the TP. For frequency range 1, the reference point for T_{UE-RX} measurement may be the Rx antenna connector of the UE and the reference point for T_{UE-TX} measurement may be the Tx antenna connector of the UE. For frequency range 2, the reference point for T_{UE-RX} measurement may be the Rx antenna of the UE and the reference point for T_{UE-TX} measurement may be the Tx antenna of the UE.

“DL reference signal time difference (DL RSTD)” is the DL relative timing difference between the Transmission Point (TP) j and the reference TP i, defined as T_{SubframeRxj}−T_{SubframeRxi}, where: T_{SubframeRxj} is the time when the UE receives the start of one subframe from TP j. T_{SubframeRxi} is the time when the UE receives the corresponding start of one subframe from TP i that is closest in time to the subframe received from TP j. Multiple DL PRS resources can be used to determine the start of one subframe from a TP. For frequency range 1, the reference point for the DL RSTD may be the antenna connector of the UE. For frequency range 2, the reference point for the DL RSTD may be the antenna of the UE.

“DL PRS reference signal received power (DL PRS-RSRP),” is defined as the linear average over the power contributions (in [W]) of the resource elements that carry DL PRS reference signals configured for RSRP measurements within the considered measurement frequency bandwidth. For frequency range 1, the reference point for the DL PRS-RSRP may be the antenna connector of the UE. For frequency range 2, DL PRS-RSRP may be measured based on the combined signal from antenna elements corresponding to a given receiver branch. For frequency range 1 and 2, if receiver diversity is in use by the UE, the reported DL PRS-RSRP value may not be lower than the corresponding DL PRS-RSRP of any of the individual receiver branches.

“DL PRS reference signal received path power (DL PRS-RSRPP),” is defined as the power of the linear average of the channel response at the i-th path delay of the resource elements that carry DL PRS signal configured for the measurement, where DL PRS-RSRPP for the 1st path delay is the power contribution corresponding to the first detected path in time. For frequency range 1, the reference point for the DL PRS-RSRPP may be the antenna connector of the UE. For frequency range 2, DL PRS-RSRPP may be measured based on the combined signal from antenna elements corresponding to a given receiver branch. For frequency range 1 and 2, if receiver diversity is in use by the UE for DL PRS-RSRPP measurements, the reported DL PRS-RSRPP value included in the higher layer parameter NR-DL-AoD-MeasElement for the first and additional measurements may be provided for the same receiver branch(es) as applied for DL PRS-RSRP measurements

“DL reference signal carrier phase (RSCP)” is defined as the phase of the channel response at the 1^{st} path delay derived from the resource elements carrying DL PRS configured for the measurement. DL RSCP is associated with the center frequency of the DL positioning frequency layer (PFL) configured for the measurement for RRC connected, RRC inactive, and RRC idle modes. For frequency range 1, the reference point for the DL RSCP may be the antenna connector of the UE. For frequency range 2, the reference point for the DL RSCP may be the antenna of the UE.

“DL reference signal carrier phase difference (RSCPD)” is defined as the difference of DL RSCPs measured from DL PRS transmitted in a DL PFL from the transmission point (TP) j and the reference TP i. If UE reports RSCPD measurements together with RSTD measurements in a measurement report element, the reference TP for RSCPD is the same as the reference TP reported for RSTD. For frequency range 1, the reference point for the DL RSCPD may be the antenna connector of the UE. For frequency range 2, the reference point for the DL RSCPD may be the antenna of the UE.

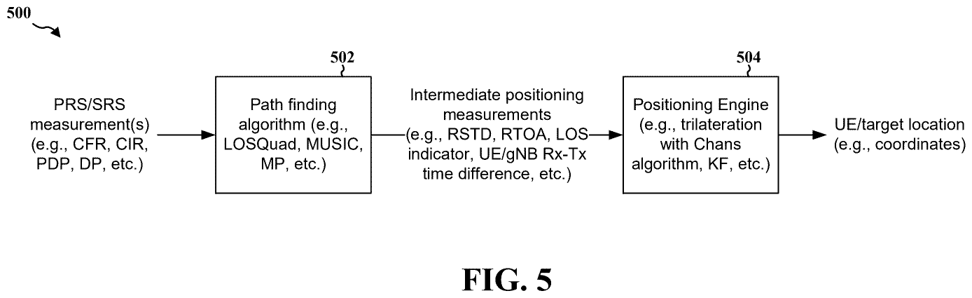

FIG. 5 is a diagram 500 illustrating an example radio access technology (RAT)-dependent positioning in accordance with various aspects of the present disclosure. For existing (e.g., classical) RAT-dependent positioning as discussed in connection with FIG. 4, as shown at 502, a positioning device/entity may be configured to input reference signal measurement(s), such as channel frequency response (CFR), channel impulse response (CIR), power delay profile (PDP), delay profile (DP) of PRS/SRS, etc., to a path finding algorithm to obtain a set of intermediate positioning measurements (e.g., RSTD, RTOA, LOS indicator, UE/gNB Rx-Tx time difference, etc.). Then, as shown at 504, the set of intermediate positioning measurements may be provided to a positioning engine (PE) to derive the location of a target, such as the coordinates of the target (which may be the positioning device itself). However, the existing RAT-dependent positioning may not be able to provide accurate positioning when the target is under non-line-of-sight (NLOS) conditions, such as when the target is in an urban dense area surrounded by tall buildings.

In some implementations, at least one artificial intelligence (AI)/machine learning (ML) (AI/ML) model may be configured/implemented at an entity/node (e.g., a UE, a network entity/node such as a base station, a location server, a location management function (LMF), etc.) for assisting the entity/node with the positioning of a UE (e.g., a target). For example, an AI/ML model may be trained to determine the position of a UE based on DL-AoA, DL-TDOA, CIR, radio frequency (RF) fingerprinting, etc. In most scenarios, using an AI/ML model may significantly improve UE positioning latency, accuracy/reliability, and/or efficiency. For example, AI/ML may enhance positioning accuracy in NLOS conditions because the AI/ML may have the capability to learns channel multipath profile and its mapping to location information.

For purposes of the present disclosure, an AI/ML model that is implemented at a UE side may be referred to as a “UE-side model” and/or “UE-side AI/ML model.” On the other hand, an AI/ML model that is implemented at a network side may be referred to as a “network-side model,” “network-side AI/ML model,” and/or (network name)-side AI/ML model (e.g., base station-side AI/ML model, LMF-side AI/ML model, etc.). In addition, positioning that is associated with a UE or a network entity/node using an AI/ML model to determine the position of the UE may be referred to as “direct AI/ML positioning,” whereas positioning that is associated with a UE or a network entity/node performing positioning related measurements using an AI/ML model (and transmitting the positioning related measurements to another entity) to determine the position of the UE may be referred to as “AI/ML assisted positioning” and/or “assisted AI/ML positioning.” Also, UE-based positioning (e.g., UE determines its own position) using at least one UE-side AI/ML model may be referred to as “direct UE AI/ML positioning” and/or “UE direct AI/ML positioning,” whereas UE-assisted positioning (e.g., a UE provides positioning measurements and a network entity, such as an LMF, determines the position for the UE based on the positioning measurements provided by the UE) using at least one UE-side AI/ML model may be referred to as “UE AI/ML assisted positioning,” “UE assisted AI/ML positioning” “AI/ML assisted UE positioning,” and/or “AI/ML UE assisted positioning,” etc. Similarly, network-based positioning (e.g., a network entity, such as an LMF, determines the position for the UE) using at least one network/LMF-side AI/ML model may be referred to as “direct network/LMF AI/ML positioning” and/or “network/LMF direct AI/ML positioning.”

For purposes of the present disclosure, at a high-level, an “AI/ML model” may refer to a program/algorithm that is capable of being trained on a set of data (which may be referred to as “training data”) to make certain decisions (without further human intervention), to recognize certain patterns, and/or predict certain outcomes, etc. In some examples and depending on the context, an “AI/ML model” may also refer to an actual physical model with given parameters and weights, and/or may refer to a logical model for which one or more models can be considered but all seen as one logical model from identification stand point. Similarly, depending on the context, an “AI/ML functionality” may refer to employing AI/ML to positioning without referring to an underlying model (physical and/or logical). The AI/ML functionality may still be defined/identified based on measurements of information considered for its inputs and/or outputs. In some examples, the AI/ML functionality may refer to one or more AI/ML model for which model input may refer to a specific measurement type/or and quantities. The one or more model(s) may be logical or physical. The AI/ML functionality may also refer to one or more AI/ML model for which model output may refer to a specific measurement type/location information and/or quantity. The one or more model(s) can be logical or physical. Depending on the context, sometimes the term “AI/ML model” may be used interchangeably with the term “AI/ML functionality,” and AI/ML model and AI/ML functionality may collectively be referred to as “AI/ML.”

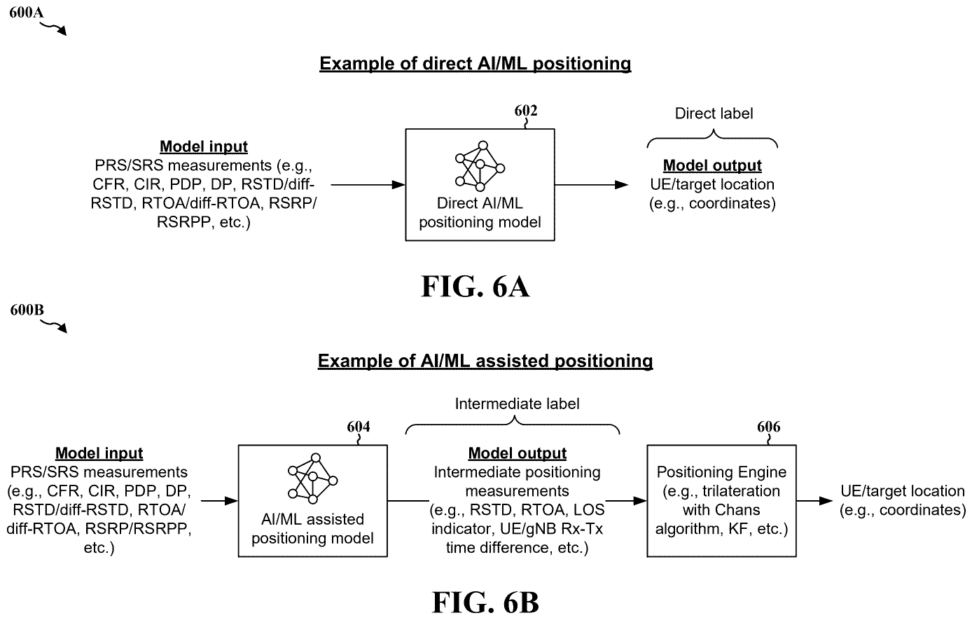

FIG. 6A is a diagram 600A illustrating an example of direct AI/ML positioning in accordance with various aspects of the present disclosure. For direct AI/ML positioning, an entity/node (e.g., a UE, a network entity/node such as a base station, a location server, etc.) may use at least one AI/ML model to determine the position of a UE or a target. For example, as shown at 602, the entity/node may input a set of PRS/SRS measurements (e.g., CFR, CIR, PDP, DP, RSTD/difference-RSTD, RTOA/difference-RTOA, RSRP/RSRPP, etc.) to a direct AI/ML positioning model, and the direct AI/ML positioning model may output the location of the UE/target, such as the coordinates of the UE/target.

FIG. 6B is a diagram 600B illustrating an example of AI/ML assisted positioning in accordance with various aspects of the present disclosure. For AI/ML assisted positioning, an entity/node (e.g., a UE, a network entity/node such as a base station, etc.) may use at least one AI/ML model to assist the measurement of reference signals (e.g., positioning reference signals such as PRS, SRS, etc.). Then, the entity/node may transmit the reference signal measurements to a location server, such as an LMF. In response, the location server may determine the position of a UE/target based on a non-AI/ML mechanism/algorithm, or based on using another AI/ML model to determine the position of the UE/target. For example, as shown at 604, the entity/node may input a set of PRS/SRS measurements (e.g., CFR, CIR, PDP, DP, RSTD/difference-RSTD, RTOA/difference-RTOA, RSRP/RSRPP, etc.) related to a UE/target to an AI/ML assisted positioning model, and the AI/ML assisted positioning model may output a set of intermediate positioning measurements (e.g., RSTD, RTOA, LOS indicator, UE/gNB Rx-Tx time difference, etc.). Then, as shown at 606, the set of intermediate positioning measurements may be provided to a positioning engine (PE) (or another AI/ML model) to derive the location of the UE/target, such as the coordinates of the UE/target (which may be the entity/node itself).

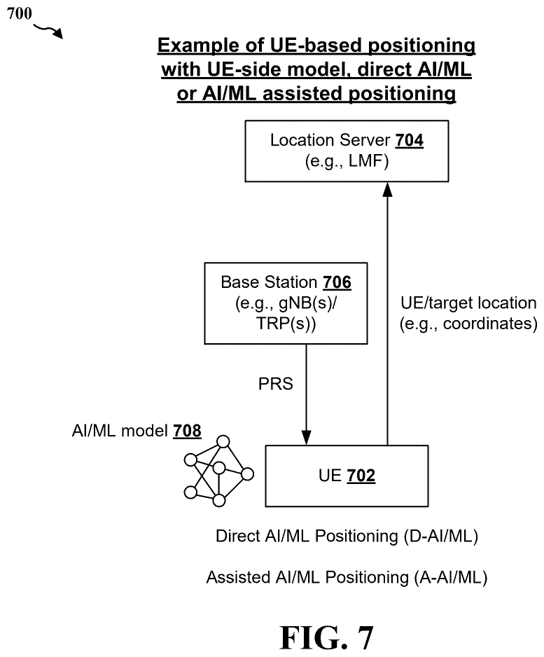

FIG. 7 is a diagram 700 illustrating an example of UE-based positioning with a UE-side AI/ML model, direct AI/ML or AI/ML assisted positioning in accordance with various aspects of the present disclosure. In one implementation, a UE 702 may be associated with at least one AI/ML model 708, and the UE 702 may use the at least one AI/ML model 708 to perform the direct AI/ML positioning and/or the assisted AI/ML positioning based on downlink (DL) reference signals, such as positioning reference signals (PRSs). For example, the UE 702 may receive and measure a set of PRSs transmitted from a base station 706 (this may also be one or more base stations and/or one or more TRPs), such as measuring the reference signal received power (RSRP), channel impulse response (CIR), DL-AoD, reference signal time difference (RSTD), time of arrival (ToA), and/or time of flight (ToF) of the set of PRSs, etc., which may be collectively be referred to as “PRS measurement(s)” and/or “PRS-based measurement(s).” In some examples, the UE 702 may use the at least one AI/ML model 708 for measuring the set of PRSs (e.g., for assisted AI/ML positioning). In some examples, based on the PRS measurement(s), the UE 702 may use the at least one AI/ML model 708 for determining its position (e.g., for direct AI/ML positioning). Note in this assisted AI/ML positioning example, the UE 702 may use the at least one AI/ML model 708 for performing PRS measurements, and the UE 702 may determine its position based on the PRS measurements without the assistance of an AI/ML model.

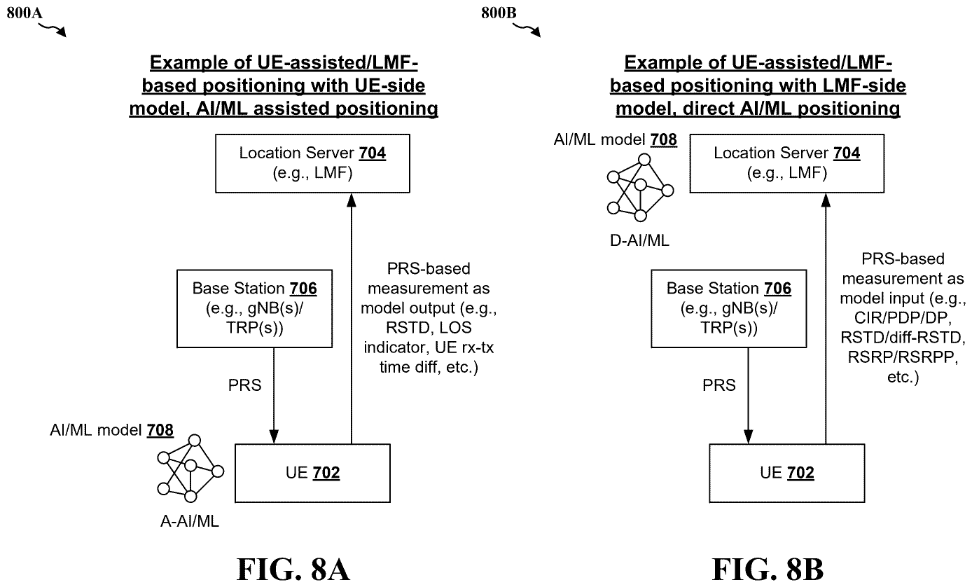

FIG. 8A is a diagram 800A illustrating an example of UE-assisted/LMF-based positioning with a UE-side AI/ML model, AI/ML assisted positioning in accordance with various aspects of the present disclosure. In another implementation, a UE 702 may be associated with at least one AI/ML model 708, and the UE 702 may use the at least one AI/ML model 708 to perform or assist measurement(s) of DL reference signals. For example, the UE 702 may receive and measure a set of PRSs transmitted from a base station 706 (this may also be one or more base stations and/or one or more TRPs) with the assistance of the at least one AI/ML model 708, which may be referred to as “PRS-based measurement(s).” Then, the UE 702 may transmit the PRS-based measurement(s) (e.g., the output of the at least one AI/ML model 708 such as the RSTD, the LOS indicator, the UE Rx-Tx time difference, etc.) to a location server 704, such as an LMF. In response, the location server 704 may determine the position of the UE 702 based on the PRS-based measurement(s) (with or without suing an AI/ML model).

FIG. 8B is a diagram 800B illustrating an example of UE-assisted/LMF-based positioning with an LMF-side AI/ML model, direct AI/ML positioning in accordance with various aspects of the present disclosure. In another implementation, a UE 702 may not include a UE-side AI/ML model, and a location server 704 may use at least one AI/ML model 708 to determine the position of the UE 702. For example, the UE 702 may receive and measure a set of PRSs transmitted from a base station 706, and the UE 702 may transmit the PRS-based measurement(s) (e.g., CIR/PDP/DP, RSTD/difference-RSTD, RSRP/RSRPP, etc.) to the location server 704, such as an LMF. Based on the PRS-based measurement(s) from the UE 702, the location server 704 may use the PRS-based measurement(s) as an input to at least one AI/ML model 708, and receive the position of the UE 702 as an output from the at least one AI/ML model 708.

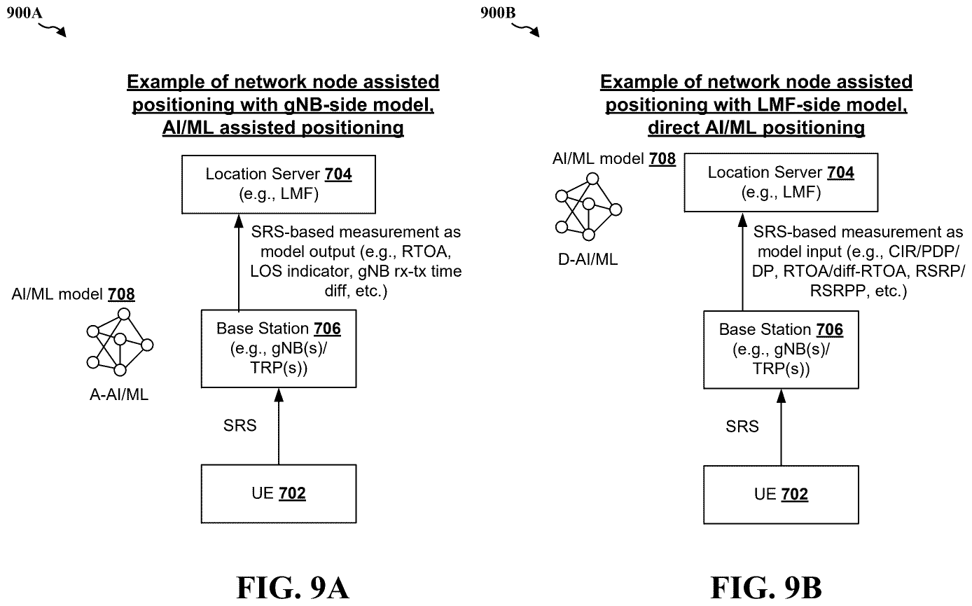

FIG. 9A is a diagram 900A illustrating an example of network (e.g., NG-RAN) node assisted positioning with a base station (gNB)-side AI/ML model, AI/ML assisted positioning in accordance with various aspects of the present disclosure. In another implementation, a network node, such as a base station 706, may be associated with at least one AI/ML model 708, and the base station 706 may use the at least one AI/ML model 708 to assist measurement(s) of uplink (UL) reference signals, such as sounding reference signals (SRSs). For example, the UE 702 may transmit a set of SRSs to the base station 706 (this may also be one or more base stations and/or one or more TRPs), and the base station 706 may receive and measure the set of SRSs (which may be referred to as “SRS-based measurement(s)”) with the assistance of the at least one AI/ML model 708. Then, the base station 706 may transmit the SRS-based measurement(s) (e.g., the output of the at least one AI/ML model 708 such as the RTOA, LOS indicator, gNB Rx-Tx time difference, etc.) to a location server 704, such as an LMF. In response, the location server 704 may determine the position of the UE 702 based on the SRS-based measurement(s) (with or without suing an AI/ML model).

FIG. 9B is a diagram 900B illustrating an example of network (e.g., NG-RAN) node assisted positioning with LMF-side AI/ML model, direct AI/ML positioning in accordance with various aspects of the present disclosure. In another implementation, a network node, such as a base station 706 (this may also be one or more base stations and/or one or more TRPs), may not include an AI/ML model, and a location server 704 may use at least one AI/ML model 708 to determine the position of a UE 702. For example, the UE 702 may transmit a set of SRSs to the base station 706, and the base station 706 may receive and measure the set of SRSs. Then, the base station 706 may transmit the SRS-based measurement(s) to the location server 704, such as an LMF. Based on the SRS-based measurement(s) from the base station 706, the location server 704 may use the SRS-based measurement(s) as an input to at least one AI/ML model 708, and receive the position of the UE 702 as an output from the at least one AI/ML model 708. For purposes of the present disclosure, positioning described in connection with FIGS. 7, 8A, and 8B may be referred to as AI/ML positioning based on DL reference signals, and positioning described in connection with FIGS. 9A and 9B may be referred to as AI/ML positioning based on UL reference signals.

In some implementations, for direct AI/ML positioning as described in connection with FIGS. 8B and 9B, type(s) of measurement(s) that may be used as (suitable/potential) input for AI/ML model inference considering performance impact and associated signaling overhead may include channel impulse response (CIR), power delay profile (PDP), reference signal receive power (RSRP), reference signal received path power (RSRPP), and/or reference signal time difference (RSTD), etc.

For AI/ML assisted positioning with UE-assisted and network node-assisted positioning described in connection with FIGS. 8A and 9A, respectively, measurement report to carry AI/ML model (suitable/potential) output to a location server such as an LMF may include ToA, path phase, RSTD, line-of-sight (LOS)/non-line-of-sight (NLOS) indicator, RSRPP, and/or soft information/high resolution of RSTD, etc. In some examples, AI/ML model inference output that may provide performance benefits may include timing estimation (note the report to LMF may be derived based on and may be different from the model inference output) and/or LOS/NLOS indicator.

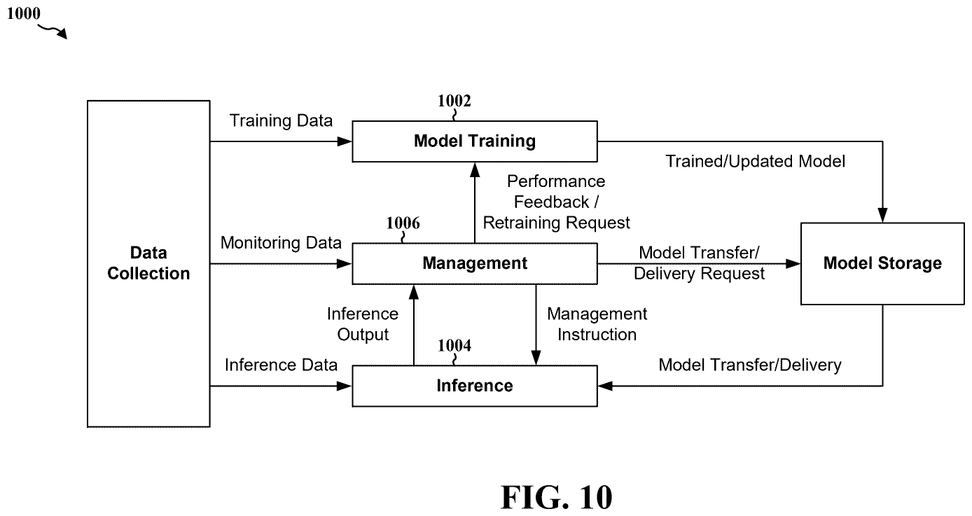

FIG. 10 is a diagram 1000 illustrating an example data monitoring related to AI/ML air interface and AI/ML positioning in accordance with various aspects of the present disclosure. In some implementations, as shown at 1006, in addition to performing AI/ML data training at 1002 and/or data inferencing at 1004, an AI/ML model may also be configured to perform data monitoring. For purposes of the present disclosure, at a high-level, AI/ML performance monitoring, AI/ML model monitor, and/or AI/ML data monitoring, etc. (collectively as “AI/ML monitoring” hereafter) may refer to monitoring the overall quality of at least one AI/ML model, which may also include monitoring inputs for the at least one AI/ML model and/or outputs from the at least one AI/ML model. For example, AI/ML monitoring may include monitoring the accuracy of positioning or positioning measurements performed by an AI/ML model, monitoring data that is used for training an AI/ML model, monitoring whether an AI/ML model is suitable under a set of specified conditions or under a specified environment, etc. There may be a variety of configurations for AI/ML model monitoring in lifecycle management, which may include: (1) monitoring based on inference accuracy (including metrics related to intermediate key performance indicators (KPIs)), (2) monitoring based on system performance (including metrics related to system performance KPIs), (3) monitoring based on data distribution, which may be input-based, e.g., monitoring the validity of the AI/ML input, e.g., out-of-distribution detection, drift detection of input data, or SNR, delay spread, etc., and/or output-based: e.g., drift detection of output data, (4) monitoring based on applicable condition. The monitoring metric calculation may be performed at the network (e.g., an LMF, a base station, etc.) or at the UE.

In some examples, methods to assess or monitor the applicability and expected performance of an inactive AI/ML model/functionality may include the following examples for the purpose of activation, selection, and/or switching of UE-side AI/ML models, UE-part of two-sided AI/ML models/functionalities (if applicable): (1) assessment/monitoring based on the additional conditions associated with the AI/ML model/functionality, (2) assessment/monitoring based on input/output data distribution, (3) assessment/monitoring using the inactive AI/ML model/functionality for monitoring purpose and measuring the inference accuracy, and/or (4) assessment/monitoring based on past knowledge of the performance of the same AI/ML model/functionality (e.g., based on other UEs), etc.

AI/ML model monitoring (e.g., monitoring in AI/ML air interface and/or AI/ML positioning) may demand one or more of the following specifications:
(a) assistance signaling and procedure at least for UE-side model;
(b) report/feedback and procedure at least for network-side model, which may include model inference and model monitoring at the same entity, and entity to perform the model monitoring may not be the same entity for model inference;
(c) data for computing monitoring metric: (1) if monitoring based on model output: e.g., estimated UE location corresponding to model output for direct AI/ML positioning, estimated intermediate parameter(s) corresponding to model output for AI/ML assisted positioning, ground-truth label corresponding to model inference output for both direct and AI/ML assisted positioning, (2) if monitoring based on model input: e.g., measurement corresponding to model inference input, (3) assistance signaling from LMF to UE/PRU/BS for UE/BS-side model monitoring, and/or (4) assistance signaling from UE/PRU for NW-side model monitoring.
(d) if certain type of data is specified/demanded for computing monitoring metric: (1) how an entity may be used to provide the given type of data for calculating monitoring metric, (2) potential signaling for provisioning of the given type of data for calculating associated monitoring metric, (3) potential assistance signaling and procedure to facilitate an entity providing data for calculating monitoring metric, and/or (4) potential UE-network interaction: e.g., model monitoring decision indication between UE and network.
(e) entity to derive monitoring metric: (1) UE at least for UE-side model (e.g., as discussed in connection with FIGS. 7 and 8A), (2) base station at least for BS (gNB)-side model (e.g., as discussed in connection with FIG. 9A), (3) LMF at least for LMF-side model (e.g., as discussed in connection with FIGS. 8B and 9B) (for AI/ML based positioning, LMF with UE-side model (e.g., as discussed in connection with FIG. 8A) and BS-side model (as discussed in connection with FIG. 9A) may be identified as the entity to derive the monitoring metric at least when monitoring is based on provided ground-truth label (or its approximation).
(f) if model monitoring does not demand ground-truth label (or its approximation): (1) statistics of measurement(s) compared to the statistics associated with the training data (note: the measurement(s) may or may not be the same as model input)—examples used in contributions: norm of model input, mean, minimum/maximum of statistics related to measurement and/or model input, median or data temporal/spatial distribution; (2) statistics of model output compared to the statistics associated with the training data and/or its own previous inference output (examples used in contributions: mean, standard deviation, variance, etc. of statistics related to model output); (3) for monitoring UE-side and BS-side model for AI/ML based positioning-signaling from LMF to facilitate the monitoring entity to derive the monitoring metric (if specified), signaling from monitoring entity to request measurement(s) (if specified), signaling for potential request/report of monitoring metric (if specified); (4) for monitoring LMF-side model for AI/ML based positioning (e.g., signaling from LMF to request measurement(s) (if specified)); (5) assistance signaling and procedure, e.g., RS configuration(s) for measurement, measurement statistics as compared to the model input statistics of the training data, etc.; and/or (6) report of the calculated metric and/or model monitoring decision.
(g) if model monitoring specifies and is provided ground-truth label (or its approximation): (1) monitoring metric-statistics of the difference between model output and provided ground-truth label (e.g., examples used in contributions: mean, standard deviation, instantaneous value, threshold of ground-truth label (or its approximation); (2) for monitoring UE-side and BS-side model for AI/ML based positioning-signaling from monitoring entity to request ground-truth label (if specified), signaling from monitoring entity to request model output (if specified), signaling for potential request/report of monitoring metric (if specified); (3) for monitoring LMF-side model for AI/ML based positioning-signaling from LMF to request measurement(s) (if specified); (4) provisioning of ground-truth label and associated label quality; (5) assistance signaling and procedure, e.g., from LMF to UE/BS indicating ground-truth label and/or measurement, etc.; and//or (6) report of the calculated metric and/or model monitoring decision.

For AI/ML based positioning such as described in connection with FIG. 9B, at least (1) timing information, and/or (2) paired timing information and power information may be supported by a base station (e.g., the base station 706) for reporting time domain channel measurements. Similarly, for AI/ML based positioning such as described in connection with FIG. 8A, at least (1) timing information, and/or (2) paired timing information and power information may be supported by a UE (e.g., the UE 702) for reporting time domain channel measurements (e.g., to a location server such as the location server 704 or an LMF).

For network node assisted positioning such as described in connection with FIG. 9A, at least LOS/NLOS indicator and/or timing information may be supported by a base station (e.g., the base station 706) for reporting (e.g., to a location server such as the location server 704). If LOS/NLOS indicator is reported by the base station, the indicator may be reported as a soft indicator or a hard indicator depending on implementations. If timing information is reported, the base station may be configured to report the timing information via UL RTOA or gNB Rx-Tx time difference. Similarly, for UE-assisted positioning such as described in connection with FIG. 8A, at least LOS/NLOS indicator and/or timing information may be supported by a UE (e.g., the UE 702) for reporting (e.g., to a location server such as the location server 704). If LOS/NLOS indicator is reported by the UE, the indicator may be reported as a soft indicator or a hard indicator depending on implementations. If timing information is reported, the base station may be configured to report the timing information via DL RSTD or UE Rx-Tx time difference.

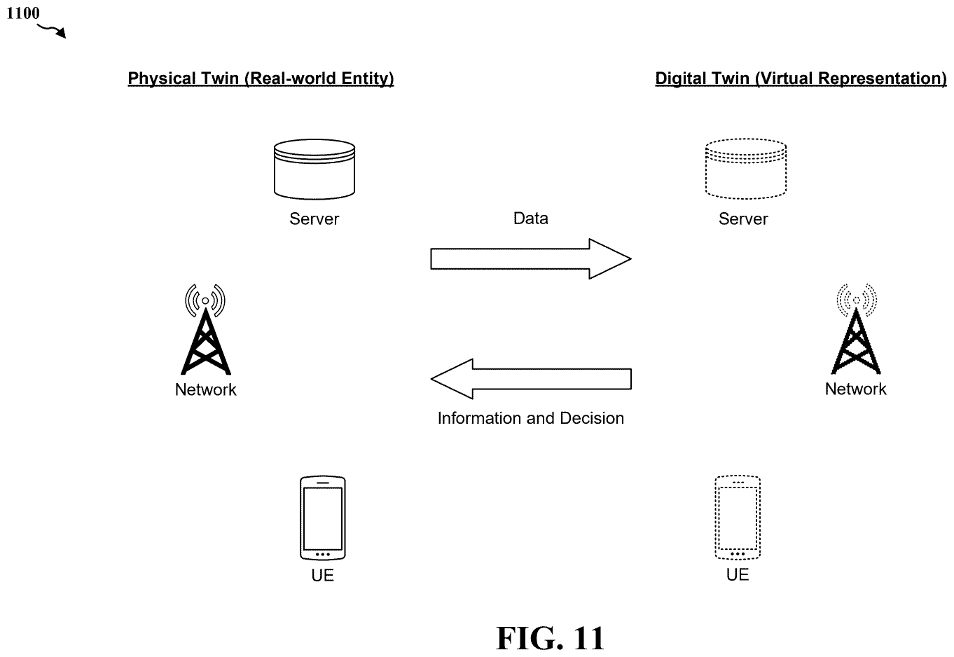

FIG. 11 is a diagram 1100 illustrating an example of digital twin in accordance with various aspects of the present disclosure. A digital twin (DT) may refer to a virtual representation of a physical object, system, or process. For example, a DT may be designed/configured to replicate the characteristics, behavior, and functionality of its counterpart (which may be referred to as its “physical twin” for purposes of the present disclosure) in a digital environment. The DT may use data collected from sensors (e.g., images from a camera, measurements from an antenna, etc.) or other sources to simulate real-time performance, predict outcomes, and support decision-making. Features of a DT may include: (1) virtual model (e.g., digitally mimics the real-world entity/physical twin), (2) dynamic updates (e.g., continuously synchronization with its physical twin using real-time data), (3) predictive capabilities (e.g., analyzes data to predict failures or optimize performance), and/or (4) applications (e.g., Used in industries like manufacturing, healthcare, smart cities, and wireless communication). As discussed above, a physical twin may refer to the actual, real-world object, system, or process that the digital twin represents. The physical twin is the tangible counterpart that exists in the physical world and generates the data used to create and maintain the digital twin. Features of a physical twin may include (1) real-world entity (e.g., the object or system being observed or managed), (2) data source (e.g., provides real-time data for the digital twin through sensors or other data collection methods), and/or (3) physical constraints (e.g., subject to wear, aging, and physical changes over time).

As illustrated by the diagram 1100, in the context of wireless communication, a DT may be a virtual representation of a physical wireless communication system or network (e.g., a combination of server(s), network entit(ies) (gNB(s)/TRP(s)), and/or UE(s), etc.), which replicates the behavior, characteristics, and operational dynamics of the actual wireless network or its components in a digital form. DTs in wireless communication may be used for various purposes, such as: (1) simulation and testing (e.g., DTs may enable virtual testing and simulation of new wireless network configurations, protocols, or upgrades without disrupting the actual network), (2) performance monitoring and optimization (e.g., DTs may continuously monitor the performance metrics of the real wireless network and provide insights for optimization and maintenance), (3) predictive analytics (e.g., by leveraging real-time data from sensors and network monitoring tools, DTs may predict potential issues or failures in the wireless network before they occur), and/or (4) training and education (e.g., DTs may be used for training purposes, allowing engineers and operators to familiarize themselves with the network behavior and test different scenarios in a controlled environment).

In other words, a DT may be thought as a digital replica of an existing entity in real world that characterizes and models its behavior, interactions, state, or evolution over time, where a DT may be an instrumental tool for large number of applications in a wireless network. For example, a DT may be constructed for a wireless channel (e.g., a DT channel and a DT radio access network (RAN), etc.) and one option is to use ray tracing (RT) for modeling the DT. For purposes of the present disclosure and in the context of the DT, ray tracing may refer to a simulation technique used to model and analyze the propagation of waves, such as electromagnetic signals, through an environment. It may be applied in areas like wireless communication, urban planning, and autonomous systems to study the behavior of signal propagation and interaction with physical structures. As such, DT of a wireless channel may involve RT as an important modeling component.

Depending on implementations, a DT may be constructed and calibrated using data from: (1) a computer-aided design (CAD) model and/or a map model, (2) a camera, (3) Lidar/radar measurements, (4) sensor measurements, (5) radio frequency (RF) measurements, and/or (6) network (NW) status and events, etc. An example DT for a wireless network may be composed of multiple models, such as (1) 3D model(s), (2) radio model(s), (3) NW model(s), and/or (4) traffic/application model(s), etc. For purposes of the present disclosure, a digital twin for a wireless network may be referred to as a “network digital twin (NDT),” which may refer to a virtual replica of a mobile network, or part of the mobile network, that captures the attributes, the behavior, and/or the interactions of the mobile network (note the mobile network may include both the RAN and the core). In some examples, the “network digital twin” may also be referred to as and/or used interchangeably with “digital twin network (DTN).”

DT technology may provide a robust support for emerging technologies by creating a comprehensive virtual mapping of the corresponding physical network process, utilizing models, operational history, and additional data. Some industries have used a network resource model (NRM) to model the attributes of a mobile network. The concept of NDT may add the ability to also model the behavior of a mobile network. This behavior is modelled by emulating or simulating a complete mobile network or limited aspects of a mobile network. An NDT may be used as a replica of a mobile network, in order to learn how an actual mobile network may behave in certain scenarios, without causing any changes to the actual mobile network. To provide meaningful results, the NDT may be specified to emulate (or simulate) the behavior of the mobile network, so that the result of the operations on the virtual replica are a good approximation to similar operations on the actual network. The standardization for an NDT may focus on implementation independent aspects of a network. By using the NDT, a wireless network management system may obtain verification results and optimize configurations, thereby avoiding failures in the actual network. This approach may benefit the optimization of the wireless network management in the telecommunications industry, reduce the cost of study and development of new technologies, and shorten the study and development cycle of new technologies.

With regards to the life-cycle management (LCM) of an NDT, when an NDT/DT consumer (which may also be referred to a “management (MnS) consumer”) submits a request to create an NDT, an NDT/DT producer (which may also be referred to a “MnS producer”) who provides the NDT may create an instance to fulfil or satisfy the specific scenarios. An NDT instance may include the following capabilities: creation, configuration, simulation start, simulation end, re-configuration, and/or deletion.

The simulation of a DT may refer to using a mathematical model to mimic how a system is likely to behave. For an NDT, models of the behavior of network functions and/or network management functions to mimic the behavior of the overall mobile network (or part thereof). To simulate the behavior of a mobile network, an NDT environment may be created that combines the models of network equipment, network functions and/or network management functions, with the relevant configuration and status data for this equipment/functions. To measure the reaction to network traffic, the network traffic may also be modelled.

The emulation of a DT may refer to using a system's actual algorithms or functions to mimic how a system may behave. For an NDT, duplicates of the network functions and/or network management functions may be executed in an NDT environment. To emulate the behavior of a mobile network, an NDT environment may be created that contains virtualized network equipment, network functions, network management functions, and all the configuration and status data for this equipment/functions. To measure the reaction to network traffic, the NDT environment may also contain traffic generators.

Example use cases where an NDT may provide support may include: verification, RAN energy saving policy verification, signaling storm configuration verification, emergency preparedness, configuration verification, visualization, network topology and traffic visualization, prediction, network failure and risk prediction, simulated data generation, and/or ML model training data generation, etc.

As discussed above, AI/ML positioning may be able to provide high positioning accuracy, such as in stringent NLOS conditions. In addition, the involvement of an NDT may also help optimize and facilitate network services. A challenge of the positioning may include how to verify and validate on positioning outcomes when provided by devices (e.g., by a UE, a base station, etc.). This challenge may be more significant/important when AI/ML is employed to obtain the positioning outcomes, because monitoring of an AI/ML positioning model/functionality may be specified frequently to verify on the validity of the AI/ML positioning model/functionality.

Aspects presented herein may improve the overall performance of AI/ML positioning by enabling a wireless device (e.g., a UE, a base station, or a TRP, etc.) or a network entity (e.g., a location server, an LMF, a sensing management function, an AI/ML management function, etc.) to use a network digital twin (NDT) to verify/validate and/or prune positioning measurements (e.g., for both the AI/ML-based positioning measurements and the non-AI/ML-based positioning measurements), and/or to verify/validate and/or prune AI/ML positioning model/functionality for a UE at a given location. For example, aspects presented herein may enable a wireless device or a network entity to verify/validate AI/ML model(s), and decide on whether to employ AI/ML and/or reference signal (RS) resources for future positioning. Aspects presented herein may enable iterative interaction between an NDT consumer (e.g., a wireless device, a network entity, etc.) and an NDT provider, in which the positioning measurements may be pruned and updated based on a coarse/updated positioning (e.g., based a coarse/updated UE location). Aspects presented herein also provide signaling specified between the NDT consumer and the NDT provider to help validate and verify positioning measurements and/or AI/ML models/functionalities.

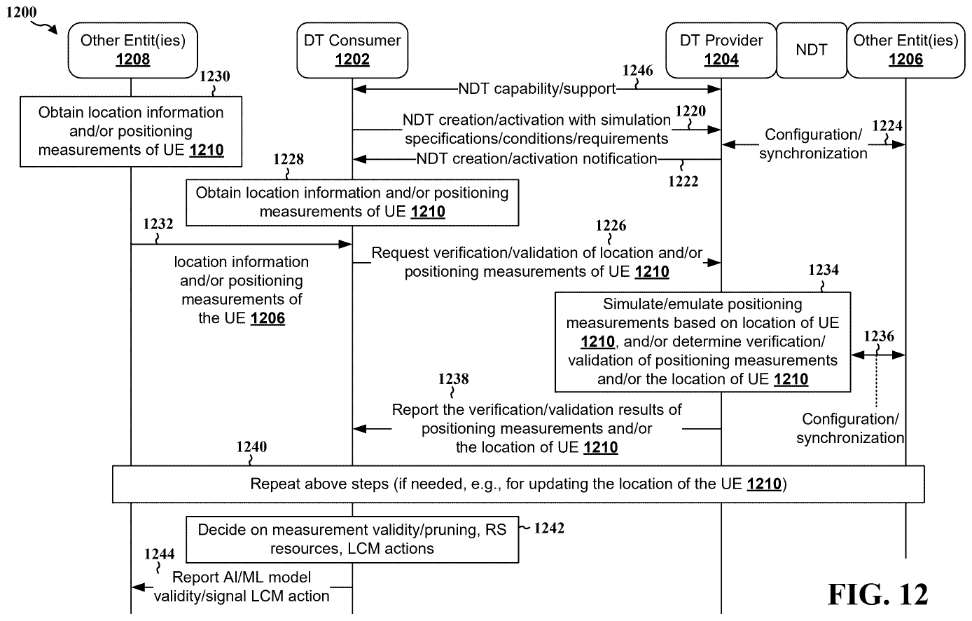

FIG. 12 is a communication flow 1200 illustrating an example of a DT consumer requesting verification/validation of data associated with a location of a UE (e.g., the location of the UE, the positioning measurements used for driving the location of the UE, etc.) in accordance with various aspects of the present disclosure. The numberings associated with the communication flow 1200 do not specify a particular temporal order and are merely used as references for the communication flow 1200. In one aspect of the present disclosure, a dedicated signaling may be configured between a digital twin (DT) consumer (which may also be referred to as a “network digital twin (NDT) consumer”) and a DT provider (which may also be referred to as an “DT producer” or an “NDT provider/producer”) to verify/validate positioning measurements and/or AI/ML positioning models/functionalities. For purposes of the present disclosure, a DT/NDT provider may refer to an entity that is responsible for creating and managing DT(s)/NDT(s), which may include generating the virtual representations, maintaining the models, and/or updating the DT(s)/NDT(s) based on real-world data. For example, the DT/NDT provider may typically be an entity or a system that: (1) collects and integrates data (e.g., uses sensors, IoT devices, or other means to gather real-world information), (2) develops models (e.g., creates the computational models and virtual environments that form the DT(s)/NDT(s)), (3) ensures accuracy (e.g., continuously updates and synchronizes the DT(s)/NDT(s) with their physical counterparts), and/or (4) provides interfaces (e.g., enables access to the DT(s)/NDT(s) through APIs, dashboards, or other tools). On the other hand, a DT/NDT consumer may refer to an entity that uses DT(s)/NDT(s) to derive value, insights, or control over the physical counterpart. For example, a DT/NDT consumer may interact with the DT(s)/NDT(s) to: (1) monitor performance (e.g., track real-time conditions or performance metrics), (2) analyze and optimize (e.g., run simulations, conduct what-if analyses, and improve operational efficiency), (3) predict outcomes (e.g., use predictive analytics and machine learning for forecasting), (4) support decision-making (e.g., inform operational, tactical, or strategic decisions), and/or (5) automate processes (e.g., enable automated responses or workflows based on insights). Depending on implementations (and in the context of positioning), a DT/NDT consumer may be a UE, a base station/TRP, a location server (e.g., an LMF), a network data analytics function (NWDAF), an AI/ML management function, a sensing management function, a network function, an operations and management (OAM) entity, an open radio access network (ORAN) entity, or an over-the-top (OTT) server, etc. A DT provider may also be a UE, a base station, a TRP, an LMF, an NWDAF, an AI/ML management function, a sensing management function, a network function, an OAM entity, an ORAN entity, or an OTT server, etc.

As an illustration, at 1220, a DT consumer 1202 may transmit, to a DT provider 1204, a request for creation/activation of DT(s)/NDT(s) and optionally with a set of simulation/emulation specifications/conditions (which may also be referred to as a set of “RAN positioning policies”). The set of simulation/emulation specifications/conditions may describe area(s), RS configuration(s), and/or network setup(s) (e.g., TRP location(s), TRP synchronization and timing error(s), TX power(s), etc.), etc. The creation/activation of DT(s)/NDT(s) may include creation/activation of a set of wireless communication entities (e.g., a set of UEs, a set of positioning reference units (PRUs), a set of base stations/TRPs, a location server, or a combination thereof), such as described in connection with FIG. 11.

In some implementations, as shown at 1224, the creation/activation of DT(s)/NDT(s) may specify the DT provider 1204 to configure and/or synchronize with a set of entities 1206 (which may include the DT consumer 1202). For example, if the DT(s)/NDT(s) include a UE, a TRP and a location server, the DT provider 1204 may configure and/or synchronize with the UE, the TRP, and/or the location server for the creation/activation of their DTs or the NDT.

At 1222, in response to the request, the DT provider 1204 may transmit a DT/NDT creation/activation notification if the DT provider 1204 is able to grant the request (e.g., the DT provider 1204 is able to create or activate the DT(s)/NDT(s) as requested by the DT consumer 1202) and also that the DT provider 1204 is able to satisfy the set of simulation/emulation specifications/conditions requested by the DT consumer 1202 (if the DT consumer 1202 indicates it at 1220).

At 1226, after the DT/NDT creation/activation, the DT consumer 1202 may transmit, to the DT provider 1204, a request to verify/validate the location of a UE 1210 or a set of measurements that is associated with deriving the location of the UE 1210 (e.g., the RTOA, RSTD, LOS indicator, UE Rx-Tx-time difference, gNB Rx-Tx time difference, RSRP, RSRPP, additional path timing information, RSCP, RSCPD, etc.). For purposes of the present disclosure, the location of a UE and the set of measurements that is associated with deriving the location of the UE may collectively be referred to as the “location data of the UE” and/or the “data associated with the location of the UE,” etc.

In some implementations, to request the DT provider 1204 to verify/validate the data associated with the location of the UE 1210, the DT consumer 1202 may be specified to provide the data associated with the location of the UE 1210 to the DT provider 1204 (note the DT consumer 1202 may also be the UE 1210). For example, as shown at 1228, if the DT consumer 1202 is the UE 1210 or a base station/TRP, the DT consumer may obtain the location information and/or the set of positioning measurements of the UE 1210 based on measurements of reference signals (e.g., PRS, SRS, etc.) transmitted between the UE 1210 and the base station/TRP. In another example, as shown at 1230, if the DT consumer is a location server, the location server may request one or more entities 1208 (e.g., the UE 1210, a base station/TRP, etc.) to obtain the location information and/or the set of positioning measurements of the UE 1210 (not shown in the communication flow 1200). Then, at 1232, the one or more entities 1208 may provide the obtained location information and/or the obtained set of positioning measurements of the UE 1210 to the DT consumer 1202. Note there may be overlapping between the set of entities 1206 and the one or more entities 1208 (e.g., they may both include the same UE 1210, the same base station(s)/TRP(s), etc.). In some examples, the DT provider 1204 may also be able to obtain the data associated with the location of the UE 1210 from another entity that is not the DT consumer 1202, such as directly from the one or more entities 1208 (not shown in the communication flow 1200).

Note while the communication flow 1200 shows the request for DT/NDT creation/activation and the request for verification/validation of location and/or set of positioning measurements of the UE 1210 are transmitted via different signaling/messages, it is merely for illustrative purposes. Depending on implementations, the DT consumer 1202 may be able to transmit both requests via the same signaling/message. For example, at 1220, the DT consumer 1202 may transmit, to the DT provider 1204, the request for DT/NDT creation/activation along with the data associated with the location of the UE 1210 (and optionally the set of simulation/emulation specifications/conditions).

In some examples, the DT consumer 1202 (at 1218) and/or the one or more entities 1208 (at 1230) may be configured to obtain the location and/or set of positioning measurements of the UE 1210 using a non-AI/ML method/functionality. For example, the set of positioning measurements may be obtained using a non-AI/ML method, and/or the coarse location of the UE 1210 may be obtained using a non-AI/ML method (and also using measurements from a non-AI/ML method).

In some examples, the DT consumer 1202 (at 1218) and/or the one or more entities 1208 (at 1230) may be configured to obtain the location and/or set of positioning measurements of the UE 1210 using an AI/ML method/model/functionality. For example, the set of positioning measurements may be obtained using an AI/ML model/functionality (e.g., the AI/ML assisted positioning such as described in connection with FIGS. 8A, 8B, 9A, and 9B). Similarly, the coarse location of the UE 1210 may be obtained using an AI/ML model/functionality (e.g., the direct AI/ML positioning such as described in connection with FIG. 7). As an alternative, the coarse location of the UE 1210 may also be obtained using a non-AI/ML method but with measurements from an AI/ML model/functionality (the AI/ML assisted positioning such as described in connection with FIGS. 8A, 8B, 9A, and 9B).

At 1234, based on the request to verify/validate the location or the set of measurements of the UE 1210, the DT provider 1204 may simulate and/or emulate the positioning measurements based on the (coarse) location of the UE 1210 and/or based on the set of measurements that is used for deriving the location of the UE 1210. As discussed above, the simulation part may be done by ray tracing and targeting the over-the-air (OTA) part of the positioning. As shown at 1236, the emulation part may be done by configuring existing virtualized equipment (e.g., the set of entities 1206, a set of TRPs, etc.) to conduct RAN related operations (e.g., RS signal baseband and passband processing) except for actual OTA part transmission/reception.

Based on the simulation and/or the emulation, the DT provider 1204 may verify or validate the location and/or the positioning measurements of the UE 1210. For example, if the DT provider 1204 simulates/emulates a set of positioning measurements (referring to as the “set of simulated/emulated positioning measurements” hereafter) based on the (coarse) location of the UE 1210 obtained from the DT consumer 1202 (e.g., at 1226), the DT provider 1204 may compare the set of simulated/emulated positioning measurements with the set of positioning measurements obtained from the DT consumer 1202 (e.g., at 1226) (referring to as the “set of actual positioning measurements” hereafter). If the set of simulated/emulated positioning measurements and the set of actual positioning measurements are consistent (e.g., their differences are below a difference threshold), the DT provider 1204 may consider the location of the UE 1210 and/or the set of actual positioning measurements used for deriving the location of the UE 1210 to be valid/verified. On the other hand, if the set of simulated/emulated positioning measurements and the set of actual positioning measurements are inconsistent (e.g., their differences are above the difference threshold), the DT provider 1204 may consider the location of the UE 1210 and/or the set of actual positioning measurements used for deriving the location of the UE 1210 to be invalid/unverified. In another example, if the DT provider 1204 simulates/emulates a location of the UE 1210 (referring to as the “simulated/emulated location” of the UE 1210 hereafter) based on the set of actual positioning measurements obtained from the DT consumer 1202 (e.g., at 1226), the DT provider 1204 may compare the simulated/emulated location of the UE 1210 with the location of the UE 1210 obtained from the DT consumer 1202 (e.g., at 1226) (referring to as the “estimated location” of the UE 1210 hereafter). If the simulated/emulated location of the UE 1210 and the estimated location of the UE 1210 are consistent (e.g., their difference is below a threshold), the DT provider 1204 may consider the estimated location of the UE 1210 and/or the set of actual positioning measurements used for deriving the location of the UE 1210 to be valid/verified. On the other hand, if the simulated/emulated location of the UE 1210 and the estimated location of the UE 1210 are inconsistent (e.g., their difference is above the threshold), the DT provider 1204 may consider the estimated location of the UE 1210 and/or the set of actual positioning measurements used for deriving the location of the UE 1210 to be invalid/unverified.

At 1238, based on the determination at 1234, the DT provider 1204 may report the verification/validation results of the location and/or the positioning measurements of the UE 1210. Depending on implementations, the DT provider 1204 may be configured to report to the DT consumer 1202: (1) the set of simulated/emulated positioning measurements and/or the simulated/emulated location of the UE 1210, (2) the difference(s) between the set of simulated/emulated positioning measurements and the set of actual positioning measurements and/or between the simulated/emulated location of the UE 1210 and the estimated location of the UE 1210, and/or (3) an indication on which positioning measurement(s) are valid (e.g., a bitmap of validity of measurements), etc.

At 1240, the DT consumer 1202, the DT provider 1204, the set of entities 1206, and/or the one or more entities 1208 may be configured to repeat one or more of the above steps (e.g., one or more steps between 1220 to 1238 if specified/demanded), such as for updating the location of the UE 1210 (e.g., to keep the location of the UE 1210 updated) and/or for maintaining the accuracy of the simulation/emulation. For example, the DT consumer 1202 may repeat (iteratively) the processes described in connection with 1226, 1228, 1234, and 1238 by providing a (second/new/updated) location of the UE 1210 along with an (optional) updated set of actual positioning measurements.

At 1242, after performing the aforementioned steps (e.g., 1220 to 1238) for one or more times, the DT consumer 1202 may use the verification/validation result(s) (e.g., received at 1238) to make decision(s) related to positioning of the UE 1210. For example, the DT consumer 1202 may use the verification/validation result(s) to decide on: (1) which RS resources to use for future positioning sessions, (2) sending a warning/notification to a device (e.g., the one or more entities 1208 which may include the UE 1210, a base station, and/or a location server/LMF, etc.) regarding the validity/verification of their positioning method(s), AI/ML model/functionality, and/or positioning measurements, etc. (e.g., via a report/message at 1244), and/or (3) the validity of an AI/ML positioning model/functionality used to obtain the location or the set of positioning measurements of the UE 1210 (e.g., if an AI/ML model/functionality is used). In some examples, if the location and/or the set of positioning measurements of the UE 1210 is determined to be invalid, the DT consumer 1202 or a device/entity (the one or more entities 1208 which may include the UE 1210, a base station, and/or a location server/LMF, etc.) may trigger an AI/ML model/functionality life-cycle management (LCM) action (e.g., activation, deactivation, selection, switching of AI/ML model/functionality or falling back to a non-AI/ML positioning method, etc.).

In some implementations, as shown at 1246, a dedicated signaling/message may also be configured to the DT consumer 1202 and the DT provider 1204 for indicating or exchanging their DT/NDT/positioning capabilities and/or supports. For example, the DT provider 1204 may indicate, to the DT consumer 1202, (1) its NDT capability for estimating the positioning measurement according to a set of RAN positioning policies, (2) its NDT capability to allow the DT consumer 1202 to configure the set of RAN positioning policies, and/or (3) its NDT capability to report the simulated/emulated impact of the set of RAN positioning policies, etc. Then, based on the indication, the DT consumer 1202 may determine whether to request the DT provider 1204 to create/activate the DT(s)/NDT(s) (e.g., at 1220). In another example, the DT provider 1204 may provide, to the DT consumer 1202, information regarding its support for DT/DTN positioning verification/validation, which may include, the maximum area boundary information (e.g., the area which the DT/DTN can be performed), the maximum RS configurations resources (e.g., the maximum bandwidth (BW), supported frequency ranges, the maximum number of resources, etc.), supported verification/validation approaches and outputs, etc. In some implementations, the DT provider 1204 may provide/signal this information as an announcement of available assistance information or data. In another example, the DT consumer 1202 may provide, to the DT provider 1204, information on support for receiving DT/DTN positioning verification/validation assistance, which may include supported outputs for verification/validation, etc. For example, the DT consumer 1202 may provide, to the DT provider 1204, information related to verification/validation of the data associated with the location of the UE 1210 which it supports (e.g., whether the DT consumer 1202 supports receiving (1) the set of simulated positioning measurements derived from the location of the UE 1210, (2) the difference between a set of positioning measurements used for an estimation of the location of the UE 1210 and the set of simulated positioning measurements, (3) the validity of the set of positioning measurements used for the estimation of the location of the UE 1210, and/or (4) the simulated location of the UE 1210 derived from the set of positioning measurements used for the estimation of the location of the UE 1210, etc. as described in connection with 1238), and/or whether the DT consumer 1202 supports forwarding the verification/validation results, etc.

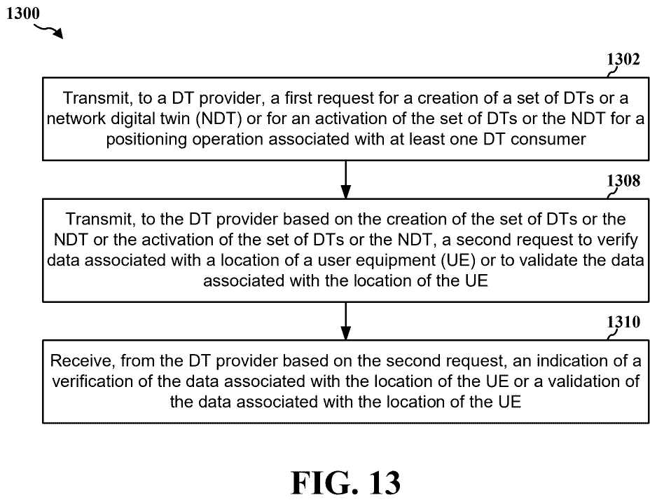

FIG. 13 is a flowchart 1300 of wireless communication. The method may be performed by a DT consumer (e.g., the UE 104, 404, 702; the base station 102, 706; the one or more location servers 168; the location server 704; the DT consumer 1202; the apparatus 1504; the network entity 1602, 1760). The method may enable the DT consumer (e.g., a UE, a base station/TRP, a location server, an LMF, etc.) to request a DT provider to verify or validate the location of a UE or a set of positioning measurement associated with deriving the location of the UE based on using a set of DTs or an NDT, thereby improving the overall performance of the positioning.

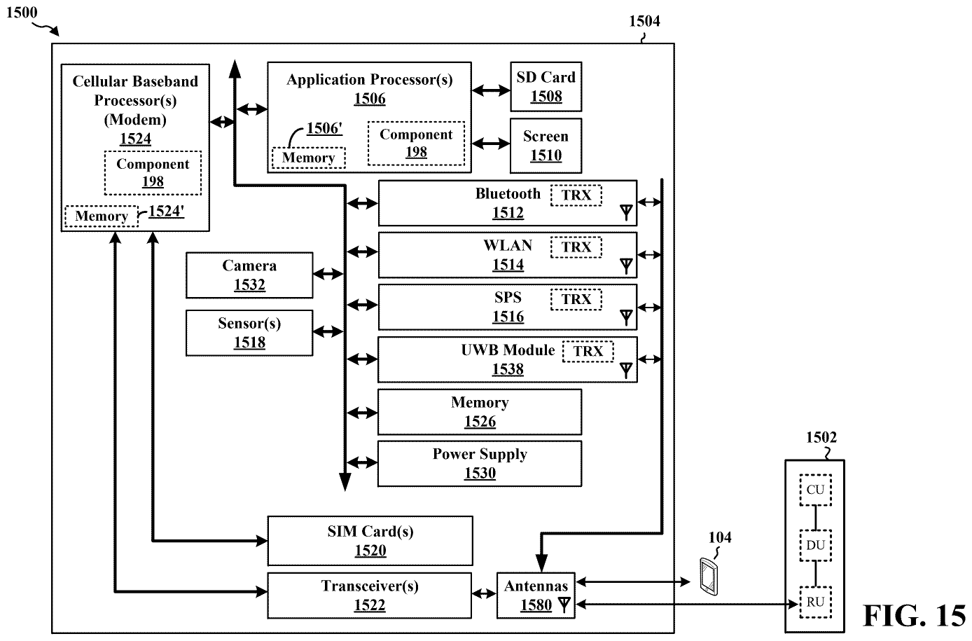

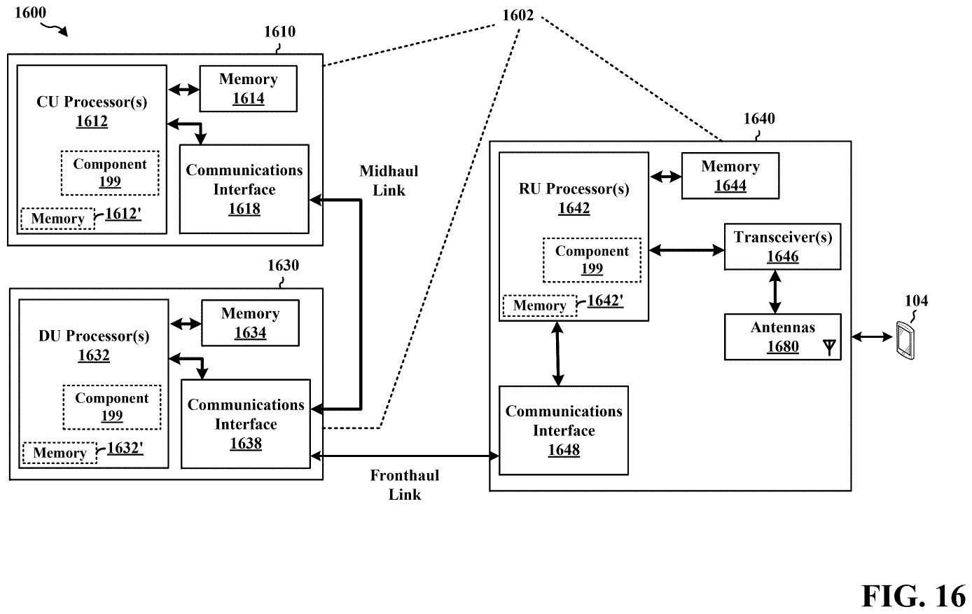

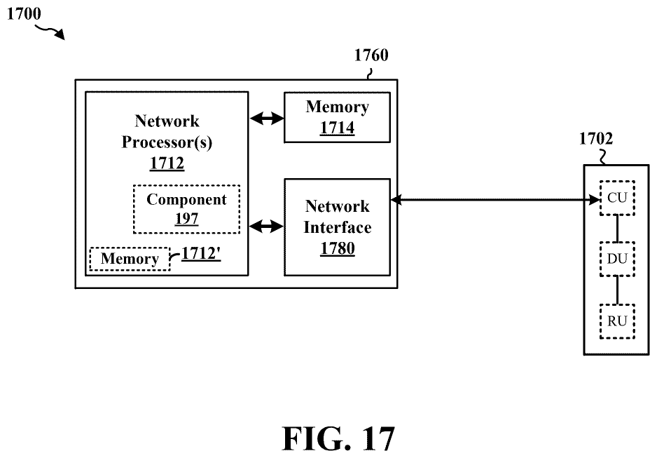

At 1302, the DT consumer may transmit, to a DT provider, a first request for a creation of a set of DTs or an NDT or for an activation of the set of DTs or the NDT for a positioning operation associated with at least one DT consumer, such as described in connection with FIG. 12. For example, at 1220, a DT consumer 1202 may transmit, to a DT provider 1204, a request for creation/activation of DT/NDT and optionally with a set of simulation/emulation specifications/conditions (which may also be referred to as a set of “RAN positioning policies”). The creation/activation of DT/NDT may include creation/activation of a set of wireless communication entities (e.g., a set of UEs, a set of positioning reference units (PRUs), a set of base stations/TRPs, a location server, or a combination thereof), such as described in connection with FIG. 11. If the DT consumer is a UE, the transmission of the first request may be performed by, e.g., the digital twin request component 198, the transceiver(s) 1522, the cellular baseband processor(s) 1524, and/or the application processor(s) 1506 of the apparatus 1504 in FIG. 15. If the DT consumer is a base station/TRP, the transmission of the first request may be performed by, e.g., the digital twin request component 199, the transceiver(s) 1646, the RU processor(s) 1642, the DU processor(s) 1632, and/or the CU processor(s) 1612, of the network entity 1602 in FIG. 16. If the DT consumer is a location server, the transmission of the first request may be performed by, e.g., the digital twin request component 197, the network processor(s) 1712, and/or the network interface 1780 of the network entity 1760 in FIG. 17.

In one example, the DT consumer corresponds to the UE, a base station, a TRP, an LMF, a network data analytics function (NWDAF), an AI/ML management function, a sensing management function, a network function, an operations and management (OAM) entity, an open radio access network (ORAN) entity, or an over-the-top (OTT) server.

In another example, the DT provider corresponds to a second UE, a base station, a TRP, an LMF, an NWDAF, an AI/ML management function, a sensing management function, a network function, an OAM entity, an ORAN entity, or an OTT server.

At 1308, the DT consumer may transmit, to the DT provider based on the creation of the set of DTs or the NDT or the activation of the set of DTs or the NDT, a second request to verify data associated with a location of a UE or to validate the data associated with the location of the UE, such as described in connection with FIG. 12. For example, at 1226, after the DT/NDT creation/activation, the DT consumer 1202 may transmit, to the DT provider 1204, a request to verify/validate the location of a UE 1210 or a set of measurements that is associated with deriving the location of the UE 1210 (e.g., the RTOA, RSTD, LOS indicator, UE Rx-Tx-time difference, gNB Rx-Tx time difference, RSRP, RSRPP, additional path timing information, RSCP, RSCPD, etc.). If the DT consumer is a UE, the transmission of the second request may be performed by, e.g., the digital twin request component 198, the transceiver(s) 1522, the cellular baseband processor(s) 1524, and/or the application processor(s) 1506 of the apparatus 1504 in FIG. 15. If the DT consumer is a base station/TRP, the transmission of the second request may be performed by, e.g., the digital twin request component 199, the transceiver(s) 1646, the RU processor(s) 1642, the DU processor(s) 1632, and/or the CU processor(s) 1612, of the network entity 1602 in FIG. 16. If the DT consumer is a location server, the transmission of the second request may be performed by, e.g., the digital twin request component 197, the network processor(s) 1712, and/or the network interface 1780 of the network entity 1760 in FIG. 17.

At 1310, the DT consumer may receive, from the DT provider based on the second request, an indication of a verification of the data associated with the location of the UE or a validation of the data associated with the location of the UE, such as described in connection with FIG. 12. For example, at 1238, the DT consumer may receive, from the DT provider 1204, the verification/validation results of the location and/or the positioning measurements of the UE 1210. If the DT consumer is a UE, the reception of the indication may be performed by, e.g., the digital twin request component 198, the transceiver(s) 1522, the cellular baseband processor(s) 1524, and/or the application processor(s) 1506 of the apparatus 1504 in FIG. 15. If the DT consumer is a base station/TRP, the reception of the indication may be performed by, e.g., the digital twin request component 199, the transceiver(s) 1646, the RU processor(s) 1642, the DU processor(s) 1632, and/or the CU processor(s) 1612, of the network entity 1602 in FIG. 16. If the DT consumer is a location server, the reception of the indication may be performed by, e.g., the digital twin request component 197, the network processor(s) 1712, and/or the network interface 1780 of the network entity 1760 in FIG. 17.

In one example, the indication of the verification of the data associated with the location of the UE includes at least one of: (1) a set of simulated positioning measurements derived from the location of the UE, (2) a difference between a set of positioning measurements used for an estimation of the location of the UE and the set of simulated positioning measurements, (3) a validity of the set of positioning measurements used for the estimation of the location of the UE, or (4) a simulated location of the UE derived from the set of positioning measurements used for the estimation of the location of the UE. In some implementations, the DT consumer may forward at least one of: (1) the set of simulated positioning measurements, (2) the difference between the set of positioning measurements and the set of simulated positioning measurements, (3) the validity of the set of positioning measurements, or (4) the simulated location of the UE.

In another example, the verification of the data associated with the location of the UE includes a positive verification or a negative verification.

In another example, the DT consumer may receive, from the DT provider based on the first request, a notification or a confirmation for the creation of the set of DTs or the NDT or the activation of the set of DTs or the NDT for the positioning operation associated with the at least one DT consumer, where transmission of the second request is based on reception of the notification or the confirmation, such as described in connection with FIG. 12. For example, at 1222, the DT consumer 1202 may receive, from the DT provider 1204, a DT/NDT creation/activation notification if the DT provider 1204 is able to grant the request (e.g., the DT provider 1204 is able to create or activate the DT/NDT as requested by the DT consumer 1202) and also that the DT provider 1204 is able to satisfy the set of simulation/emulation specifications/conditions requested by the DT consumer 1202 (if the DT consumer 1202 indicates it at 1220). If the DT consumer is a UE, the reception of the notification or the confirmation may be performed by, e.g., the digital twin request component 198, the transceiver(s) 1522, the cellular baseband processor(s) 1524, and/or the application processor(s) 1506 of the apparatus 1504 in FIG. 15. If the DT consumer is a base station/TRP, the reception of the notification or the confirmation may be performed by, e.g., the digital twin request component 199, the transceiver(s) 1646, the RU processor(s) 1642, the DU processor(s) 1632, and/or the CU processor(s) 1612, of the network entity 1602 in FIG. 16. If the DT consumer is a location server, the reception of the notification or the confirmation may be performed by, e.g., the digital twin request component 197, the network processor(s) 1712, and/or the network interface 1780 of the network entity 1760 in FIG. 17. In some implementations, the first request includes a set of simulation or emulation specifications, and reception of the notification or the confirmation for the creation of the set of DTs or the NDT or the activation of the set of DTs or the NDT is based on the set of simulation or emulation specifications being able to be satisfied by the DT provider. In some implementations, the set of simulation or emulation specifications includes at least one of a designated area, a set of RS configurations, or a specified network setup.

In another example, the data includes at least one of the location of the UE or a set of positioning measurements used for an estimation of the location of the UE. In some implementations, the DT consumer may obtain at least one of the location of the UE or the set of positioning measurements, and transmit, to the DT provider, at least one of the location of the UE or the set of positioning measurements, such as described in connection with FIG. 12. For example, at 1228, if the DT consumer 1202 is the UE 1210 or a base station/TRP, the DT consumer may obtain the location information and/or the set of positioning measurements of the UE 1210 based on measurements of reference signals (e.g., PRS, SRS, etc.) transmitted between the UE 1210 and the base station/TRP. In another example, as shown at 1230, if the DT consumer is a location server, the location server may request one or more entities 1208 (e.g., the UE 1210, a base station/TRP, etc.) to obtain the location information and/or the set of positioning measurements of the UE 1210 (not shown in the communication flow 1200). If the DT consumer is a UE, the obtainment/transmission of the location of the UE or the set of positioning measurements may be performed by, e.g., the digital twin request component 198, the SPS module 1516, the transceiver(s) 1522, the cellular baseband processor(s) 1524, and/or the application processor(s) 1506 of the apparatus 1504 in FIG. 15. If the DT consumer is a base station/TRP, the obtainment/transmission of the location of the UE or the set of positioning measurements may be performed by, e.g., the digital twin request component 199, the transceiver(s) 1646, the RU processor(s) 1642, the DU processor(s) 1632, and/or the CU processor(s) 1612, of the network entity 1602 in FIG. 16. If the DT consumer is a location server, the obtainment/transmission of the location of the UE or the set of positioning measurements may be performed by, e.g., the digital twin request component 197, the network processor(s) 1712, and/or the network interface 1780 of the network entity 1760 in FIG. 17. In some implementations, to obtain at least one of the location of the UE or the set of positioning measurements, the DT consumer may be configured to receive at least one of the location of the UE or the set of positioning measurements from the UE, a base station, a TRP, or an LMF. In some implementations, to obtain at least one of the location of the UE or the set of positioning measurements, the DT consumer may be configured to obtain at least one of the location of the UE or the set of positioning measurements using AI/ML.

In another example, the DT consumer may determine, based on the indication of the verification of the data associated with the location of the UE or the validation of the data associated with the location of the UE, a set of decisions related to positioning of the UE, such as described in connection with FIG. 12. For example, at 1242, DT consumer 1202 may use the verification/validation result(s) (e.g., received at 1238) to make decision(s) related to positioning of the UE 1210. For example, the DT consumer 1202 may use the verification/validation result(s) to decide on: (1) which RS resources to use for future positioning sessions, (2) sending a warning/notification to a device (e.g., the one or more entities 1208 which may include the UE 1210, a base station, and/or a location server/LMF, etc.) regarding the validity/verification of their positioning method(s), AI/ML model/functionality, and/or positioning measurements, etc. (e.g., via a report/message at 1244), and/or (3) the validity of an AI/ML positioning model/functionality used to obtain the location or the set of positioning measurements of the UE 1210 (e.g., if an AI/ML model/functionality is used). If the DT consumer is a UE, the determination of the set of decisions may be performed by, e.g., the digital twin request component 198, the transceiver(s) 1522, the cellular baseband processor(s) 1524, and/or the application processor(s) 1506 of the apparatus 1504 in FIG. 15. If the DT consumer is a base station/TRP, the determination of the set of decisions may be performed by, e.g., the digital twin request component 199, the transceiver(s) 1646, the RU processor(s) 1642, the DU processor(s) 1632, and/or the CU processor(s) 1612, of the network entity 1602 in FIG. 16. If the DT consumer is a location server, the determination of the set of decisions may be performed by, e.g., the digital twin request component 197, the network processor(s) 1712, and/or the network interface 1780 of the network entity 1760 in FIG. 17.

In another example, the DT consumer may transmit, based on reception of the indication, a message indicating a validity for at least one of: the location of the UE, a set of positioning measurements used for an estimation of the location of the UE, a positioning method used for the estimation of the location of the UE, a measurement method used for obtaining the set of positioning measurements, or an AI/ML model or functionality used for an obtainment of the location of the UE or the set of positioning measurements, such as described in connection with FIG. 12. For example, at 1242, the DT consumer 1202 may use the verification/validation result(s) to decide on: (1) which RS resources to use for future positioning sessions, (2) sending a warning/notification to a device (e.g., the one or more entities 1208 which may include the UE 1210, a base station, and/or a location server/LMF, etc.) regarding the validity/verification of their positioning method(s), AI/ML model/functionality, and/or positioning measurements, etc. (e.g., via a report/message at 1244), and/or (3) the validity of an AI/ML positioning model/functionality used to obtain the location or the set of positioning measurements of the UE 1210 (e.g., if an AI/ML model/functionality is used). If the DT consumer is a UE, the transmission of the message may be performed by, e.g., the digital twin request component 198, the transceiver(s) 1522, the cellular baseband processor(s) 1524, and/or the application processor(s) 1506 of the apparatus 1504 in FIG. 15. If the DT consumer is a base station/TRP, the transmission of the message may be performed by, e.g., the digital twin request component 199, the transceiver(s) 1646, the RU processor(s) 1642, the DU processor(s) 1632, and/or the CU processor(s) 1612, of the network entity 1602 in FIG. 16. If the DT consumer is a location server, the transmission of the message may be performed by, e.g., the digital twin request component 197, the network processor(s) 1712, and/or the network interface 1780 of the network entity 1760 in FIG. 17.

In another example, the DT consumer may transmit or receive a set of capabilities or supports related to the set of DTs or the NDT for the positioning operation.

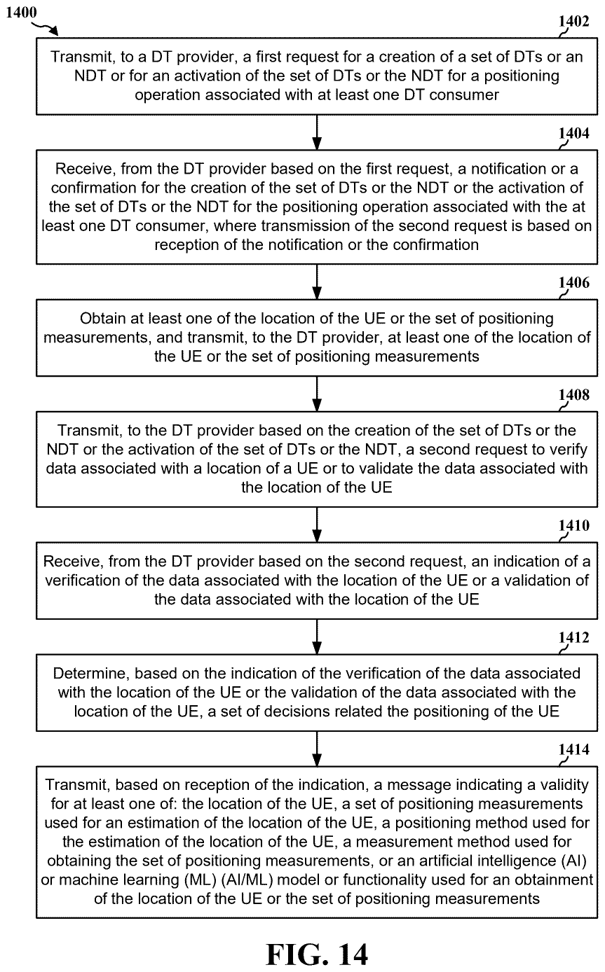

FIG. 14 is a flowchart 1400 of wireless communication. The method may be performed by a DT consumer (e.g., the UE 104, 404, 702; the base station 102, 706; the one or more location servers 168; the location server 704; the DT consumer 1202; the apparatus 1504; the network entity 1602, 1760). The method may enable the DT consumer (e.g., a UE, a base station/TRP, a location server, an LMF, etc.) to request a DT provider to verify or validate the location of a UE or a set of positioning measurement associated with deriving the location of the UE based on using a set of DTs or an NDT, thereby improving the overall performance of the positioning.

At 1402, the DT consumer may transmit, to a DT provider, a first request for a creation of a set of DTs or an NDT or for an activation of the set of DTs or the NDT for a positioning operation associated with at least one DT consumer, such as described in connection with FIG. 12. For example, at 1220, a DT consumer 1202 may transmit, to a DT provider 1204, a request for creation/activation of DT/NDT and optionally with a set of simulation/emulation specifications/conditions (which may also be referred to as a set of “RAN positioning policies”). The creation/activation of DT/NDT may include creation/activation of a set of wireless communication entities (e.g., a set of UEs, a set of positioning reference units (PRUs), a set of base stations/TRPs, a location server, or a combination thereof), such as described in connection with FIG. 11. If the DT consumer is a UE, the transmission of the first request may be performed by, e.g., the digital twin request component 198, the transceiver(s) 1522, the cellular baseband processor(s) 1524, and/or the application processor(s) 1506 of the apparatus 1504 in FIG. 15. If the DT consumer is a base station/TRP, the transmission of the first request may be performed by, e.g., the digital twin request component 199, the transceiver(s) 1646, the RU processor(s) 1642, the DU processor(s) 1632, and/or the CU processor(s) 1612, of the network entity 1602 in FIG. 16. If the DT consumer is a location server, the transmission of the first request may be performed by, e.g., the digital twin request component 197, the network processor(s) 1712, and/or the network interface 1780 of the network entity 1760 in FIG. 17.

In one example, the DT consumer corresponds to the UE, a base station, a TRP, an LMF, an NWDAF, an AI/ML management function, or a sensing management function, a network function, an OAM entity, an ORAN entity, or an OTT server.

In another example, the DT provider corresponds to a second UE, a base station, a TRP, an LMF, an NWDAF, an AI/ML management function, a sensing management function, a network function, an OAM entity, an ORAN entity, or an OTT server.

At 1408, the DT consumer may transmit, to the DT provider based on the creation of the set of DTs or the NDT or the activation of the set of DTs or the NDT, a second request to verify data associated with a location of a UE or to validate the data associated with the location of the UE, such as described in connection with FIG. 12. For example, at 1226, after the DT/NDT creation/activation, the DT consumer 1202 may transmit, to the DT provider 1204, a request to verify/validate the location of a UE 1210 or a set of measurements that is associated with deriving the location of the UE 1210 (e.g., the RTOA, RSTD, LOS indicator, UE Rx-Tx-time difference, gNB Rx-Tx time difference, RSRP, RSRPP, additional path timing information, RSCP, RSCPD, etc.). If the DT consumer is a UE, the transmission of the second request may be performed by, e.g., the digital twin request component 198, the transceiver(s) 1522, the cellular baseband processor(s) 1524, and/or the application processor(s) 1506 of the apparatus 1504 in FIG. 15. If the DT consumer is a base station/TRP, the transmission of the second request may be performed by, e.g., the digital twin request component 199, the transceiver(s) 1646, the RU processor(s) 1642, the DU processor(s) 1632, and/or the CU processor(s) 1612, of the network entity 1602 in FIG. 16. If the DT consumer is a location server, the transmission of the second request may be performed by, e.g., the digital twin request component 197, the network processor(s) 1712, and/or the network interface 1780 of the network entity 1760 in FIG. 17.

At 1410, the DT consumer may receive, from the DT provider based on the second request, an indication of a verification of the data associated with the location of the UE or a validation of the data associated with the location of the UE, such as described in connection with FIG. 12. For example, at 1238, the DT consumer may receive, from the DT provider 1204, the verification/validation results of the location and/or the positioning measurements of the UE 1210. If the DT consumer is a UE, the reception of the indication may be performed by, e.g., the digital twin request component 198, the transceiver(s) 1522, the cellular baseband processor(s) 1524, and/or the application processor(s) 1506 of the apparatus 1504 in FIG. 15. If the DT consumer is a base station/TRP, the reception of the indication may be performed by, e.g., the digital twin request component 199, the transceiver(s) 1646, the RU processor(s) 1642, the DU processor(s) 1632, and/or the CU processor(s) 1612, of the network entity 1602 in FIG. 16. If the DT consumer is a location server, the reception of the indication may be performed by, e.g., the digital twin request component 197, the network processor(s) 1712, and/or the network interface 1780 of the network entity 1760 in FIG. 17.

In one example, the indication of the verification of the data associated with the location of the UE includes at least one of: (1) a set of simulated positioning measurements derived from the location of the UE, (2) a difference between a set of positioning measurements used for an estimation of the location of the UE and the set of simulated positioning measurements, (3) a validity of the set of positioning measurements used for the estimation of the location of the UE, or (4) a simulated location of the UE derived from the set of positioning measurements used for the estimation of the location of the UE. In some implementations, the DT consumer may forward at least one of: (1) the set of simulated positioning measurements, (2) the difference between the set of positioning measurements and the set of simulated positioning measurements, (3) the validity of the set of positioning measurements, or (4) the simulated location of the UE.

In another example, the verification of the data associated with the location of the UE includes a positive verification or a negative verification.

In another example, as shown at 1404, the DT consumer may receive, from the DT provider based on the first request, a notification or a confirmation for the creation of the set of DTs or the NDT or the activation of the set of DTs or the NDT for the positioning operation associated with the at least one DT consumer, where transmission of the second request is based on reception of the notification or the confirmation, such as described in connection with FIG. 12. For example, at 1222, the DT consumer 1202 may receive, from the DT provider 1204, a DT/NDT creation/activation notification if the DT provider 1204 is able to grant the request (e.g., the DT provider 1204 is able to create or activate the DT/NDT as requested by the DT consumer 1202) and also that the DT provider 1204 is able to satisfy the set of simulation/emulation specifications/conditions requested by the DT consumer 1202 (if the DT consumer 1202 indicates it at 1220). If the DT consumer is a UE, the reception of the notification or the confirmation may be performed by, e.g., the digital twin request component 198, the transceiver(s) 1522, the cellular baseband processor(s) 1524, and/or the application processor(s) 1506 of the apparatus 1504 in FIG. 15. If the DT consumer is a base station/TRP, the reception of the notification or the confirmation may be performed by, e.g., the digital twin request component 199, the transceiver(s) 1646, the RU processor(s) 1642, the DU processor(s) 1632, and/or the CU processor(s) 1612, of the network entity 1602 in FIG. 16. If the DT consumer is a location server, the reception of the notification or the confirmation may be performed by, e.g., the digital twin request component 197, the network processor(s) 1712, and/or the network interface 1780 of the network entity 1760 in FIG. 17. In some implementations, the first request includes a set of simulation or emulation specifications, and reception of the notification or the confirmation for the creation of the set of DTs or the NDT or the activation of the set of DTs or the NDT is based on the set of simulation or emulation specifications being able to be satisfied by the DT provider. In some implementations, the set of simulation or emulation specifications includes at least one of a designated area, a set of RS configurations, or a specified network setup.

In another example, the data includes at least one of the location of the UE or a set of positioning measurements used for an estimation of the location of the UE. In some implementations, as shown at 1406, the DT consumer may obtain at least one of the location of the UE or the set of positioning measurements, and transmit, to the DT provider, at least one of the location of the UE or the set of positioning measurements, such as described in connection with FIG. 12. For example, at 1228, if the DT consumer 1202 is the UE 1210 or a base station/TRP, the DT consumer may obtain the location information and/or the set of positioning measurements of the UE 1210 based on measurements of reference signals (e.g., PRS, SRS, etc.) transmitted between the UE 1210 and the base station/TRP. In another example, as shown at 1230, if the DT consumer is a location server, the location server may request one or more entities 1208 (e.g., the UE 1210, a base station/TRP, etc.) to obtain the location information and/or the set of positioning measurements of the UE 1210 (not shown in the communication flow 1200). If the DT consumer is a UE, the obtainment/transmission of the location of the UE or the set of positioning measurements may be performed by, e.g., the digital twin request component 198, the SPS module 1516, the transceiver(s) 1522, the cellular baseband processor(s) 1524, and/or the application processor(s) 1506 of the apparatus 1504 in FIG. 15. If the DT consumer is a base station/TRP, the obtainment/transmission of the location of the UE or the set of positioning measurements may be performed by, e.g., the digital twin request component 199, the transceiver(s) 1646, the RU processor(s) 1642, the DU processor(s) 1632, and/or the CU processor(s) 1612, of the network entity 1602 in FIG. 16. If the DT consumer is a location server, the obtainment/transmission of the location of the UE or the set of positioning measurements may be performed by, e.g., the digital twin request component 197, the network processor(s) 1712, and/or the network interface 1780 of the network entity 1760 in FIG. 17. In some implementations, to obtain at least one of the location of the UE or the set of positioning measurements, the DT consumer may be configured to receive at least one of the location of the UE or the set of positioning measurements from the UE, a base station, a TRP, or an LMF. In some implementations, to obtain at least one of the location of the UE or the set of positioning measurements, the DT consumer may be configured to obtain at least one of the location of the UE or the set of positioning measurements using AI/ML.

In another example, as shown at 1412, the DT consumer may determine, based on the indication of the verification of the data associated with the location of the UE or the validation of the data associated with the location of the UE, a set of decisions related to positioning of the UE, such as described in connection with FIG. 12. For example, at 1242, DT consumer 1202 may use the verification/validation result(s) (e.g., received at 1238) to make decision(s) related to positioning of the UE 1210. For example, the DT consumer 1202 may use the verification/validation result(s) to decide on: (1) which RS resources to use for future positioning sessions, (2) sending a warning/notification to a device (e.g., the one or more entities 1208 which may include the UE 1210, a base station, and/or a location server/LMF, etc.) regarding the validity/verification of their positioning method(s), AI/ML model/functionality, and/or positioning measurements, etc. (e.g., via a report/message at 1244), and/or (3) the validity of an AI/ML positioning model/functionality used to obtain the location or the set of positioning measurements of the UE 1210 (e.g., if an AI/ML model/functionality is used). If the DT consumer is a UE, the determination of the set of decisions may be performed by, e.g., the digital twin request component 198, the transceiver(s) 1522, the cellular baseband processor(s) 1524, and/or the application processor(s) 1506 of the apparatus 1504 in FIG. 15. If the DT consumer is a base station/TRP, the determination of the set of decisions may be performed by, e.g., the digital twin request component 199, the transceiver(s) 1646, the RU processor(s) 1642, the DU processor(s) 1632, and/or the CU processor(s) 1612, of the network entity 1602 in FIG. 16. If the DT consumer is a location server, the determination of the set of decisions may be performed by, e.g., the digital twin request component 197, the network processor(s) 1712, and/or the network interface 1780 of the network entity 1760 in FIG. 17.

In another example, as shown at 1414, the DT consumer may transmit, based on reception of the indication, a message indicating a validity for at least one of: the location of the UE, a set of positioning measurements used for an estimation of the location of the UE, a positioning method used for the estimation of the location of the UE, a measurement method used for obtaining the set of positioning measurements, or an AI/ML model or functionality used for an obtainment of the location of the UE or the set of positioning measurements, such as described in connection with FIG. 12. For example, at 1242, the DT consumer 1202 may use the verification/validation result(s) to decide on: (1) which RS resources to use for future positioning sessions, (2) sending a warning/notification to a device (e.g., the one or more entities 1208 which may include the UE 1210, a base station, and/or a location server/LMF, etc.) regarding the validity/verification of their positioning method(s), AI/ML model/functionality, and/or positioning measurements, etc. (e.g., via a report/message at 1244), and/or (3) the validity of an AI/ML positioning model/functionality used to obtain the location or the set of positioning measurements of the UE 1210 (e.g., if an AI/ML model/functionality is used). If the DT consumer is a UE, the transmission of the message may be performed by, e.g., the digital twin request component 198, the transceiver(s) 1522, the cellular baseband processor(s) 1524, and/or the application processor(s) 1506 of the apparatus 1504 in FIG. 15. If the DT consumer is a base station/TRP, the transmission of the message may be performed by, e.g., the digital twin request component 199, the transceiver(s) 1646, the RU processor(s) 1642, the DU processor(s) 1632, and/or the CU processor(s) 1612, of the network entity 1602 in FIG. 16. If the DT consumer is a location server, the transmission of the message may be performed by, e.g., the digital twin request component 197, the network processor(s) 1712, and/or the network interface 1780 of the network entity 1760 in FIG. 17.

In another example, the DT consumer may transmit or receive a set of capabilities or supports related to the set of DTs or the NDT for the positioning operation.

FIG. 15 is a diagram 1500 illustrating an example of a hardware implementation for an apparatus 1504. The apparatus 1504 may be a UE, a component of a UE, or may implement UE functionality. In some aspects, the apparatus 1504 may include at least one cellular baseband processor 1524 (also referred to as a modem) coupled to one or more transceivers 1522 (e.g., cellular RF transceiver). The cellular baseband processor(s) 1524 may include at least one on-chip memory 1524′. In some aspects, the apparatus 1504 may further include one or more subscriber identity modules (SIM) cards 1520 and at least one application processor 1506 coupled to a secure digital (SD) card 1508 and a screen 1510. The application processor(s) 1506 may include on-chip memory 1506′. In some aspects, the apparatus 1504 may further include a Bluetooth module 1512, a WLAN module 1514, an ultrawide band (UWB) module 1538 (e.g., a UWB transceiver), an SPS module 1516 (e.g., GNSS module), one or more sensors 1518 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1526, a power supply 1530, and/or a camera 1532. The Bluetooth module 1512, the UWB module 1538, the WLAN module 1514, and the SPS module 1516 may include an on-chip transceiver (TRX) (or in some cases, just a receiver (RX)). The Bluetooth module 1512, the WLAN module 1514, and the SPS module 1516 may include their own dedicated antennas and/or utilize the antennas 1580 for communication. The cellular baseband processor(s) 1524 communicates through the transceiver(s) 1522 via one or more antennas 1580 with the UE 104 and/or with an RU associated with a network entity 1502. The cellular baseband processor(s) 1524 and the application processor(s) 1506 may each include a computer-readable medium/memory 1524′, 1506′, respectively. The additional memory modules 1526 may also be considered a computer-readable medium/memory. Each computer-readable medium/memory 1524′, 1506′, 1526 may be non-transitory. The cellular baseband processor(s) 1524 and the application processor(s) 1506 are each responsible for general processing, including the execution of software stored on the computer-readable medium/memory. The software, when executed by the cellular baseband processor(s) 1524/application processor(s) 1506, causes the cellular baseband processor(s) 1524/application processor(s) 1506 to perform the various functions described supra. The cellular baseband processor(s) 1524 and the application processor(s) 1506 are configured to perform the various functions described supra based at least in part of the information stored in the memory. That is, the cellular baseband processor(s) 1524 and the application processor(s) 1506 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1524/application processor(s) 1506 when executing software. The cellular baseband processor(s) 1524/application processor(s) 1506 may be a component of the UE 350 and may include the at least one memory 360 and/or at least one of the TX processor 368, the RX processor 356, and the controller/processor 359. In one configuration, the apparatus 1504 may be at least one processor chip (modem and/or application) and include just the cellular baseband processor(s) 1524 and/or the application processor(s) 1506, and in another configuration, the apparatus 1504 may be the entire UE (e.g., see UE 350 of FIG. 3) and include the additional modules of the apparatus 1504.

As discussed supra, the digital twin request component 198 may be configured to transmit, to a DT provider, a first request for a creation of a set of DTs or an NDT or for an activation of the set of DTs or the NDT for a positioning operation associated with at least one DT consumer. The digital twin request component 198 may also be configured to transmit, to the DT provider based on the creation of the set of DTs or the NDT or the activation of the set of DTs or the NDT, a second request to verify data associated with a location of a UE or to validate the data associated with the location of the UE. The digital twin request component 198 may also be configured to receive, from the DT provider based on the second request, an indication of a verification of the data associated with the location of the UE or a validation of the data associated with the location of the UE. The digital twin request component 198 may be within the cellular baseband processor(s) 1524, the application processor(s) 1506, or both the cellular baseband processor(s) 1524 and the application processor(s) 1506. The digital twin request component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1504 may include a variety of components configured for various functions. In one configuration, the apparatus 1504, and in particular the cellular baseband processor(s) 1524 and/or the application processor(s) 1506, may include means for transmitting, to a DT provider, a first request for a creation of a set of DTs or an NDT or for an activation of the set of DTs or the NDT for a positioning operation associated with at least one DT consumer. The apparatus 1504 may further include means for transmitting, to the DT provider based on the creation of the set of DTs or the NDT or the activation of the set of DTs or the NDT, a second request to verify data associated with a location of a UE or to validate the data associated with the location of the UE. The apparatus 1504 may further include means for receiving, from the DT provider based on the second request, an indication of a verification of the data associated with the location of the UE or a validation of the data associated with the location of the UE.

In one configuration, the indication of the verification of the data associated with the location of the UE includes at least one of: (1) a set of simulated positioning measurements derived from the location of the UE, (2) a difference between a set of positioning measurements used for an estimation of the location of the UE and the set of simulated positioning measurements, (3) a validity of the set of positioning measurements used for the estimation of the location of the UE, or (4) a simulated location of the UE derived from the set of positioning measurements used for the estimation of the location of the UE. In some implementations, the DT consumer may forward at least one of: (1) the set of simulated positioning measurements, (2) the difference between the set of positioning measurements and the set of simulated positioning measurements, (3) the validity of the set of positioning measurements, or (4) the simulated location of the UE.

In another configuration, the verification of the data associated with the location of the UE includes a positive verification or a negative verification.

In another configuration, the apparatus 1504 may further include means for receiving, from the DT provider based on the first request, a notification or a confirmation for the creation of the set of DTs or the NDT or the activation of the set of DTs or the NDT for the positioning operation associated with the at least one DT consumer, where transmission of the second request is based on reception of the notification or the confirmation. In some implementations, the first request includes a set of simulation or emulation specifications, and reception of the notification or the confirmation for the creation of the set of DTs or the NDT or the activation of the set of DTs or the NDT is based on the set of simulation or emulation specifications being able to be satisfied by the DT provider. In some implementations, the set of simulation or emulation specifications includes at least one of a designated area, a set of RS configurations, or a specified network setup.

In another configuration, the data includes at least one of the location of the UE or a set of positioning measurements used for an estimation of the location of the UE. In some implementations, the apparatus 1504 may further include means for obtaining at least one of the location of the UE or the set of positioning measurements, and transmit, to the DT provider, at least one of the location of the UE or the set of positioning measurements. In some implementations, the means for obtaining at least one of the location of the UE or the set of positioning measurements may include configuring the apparatus 1504 to receive at least one of the location of the UE or the set of positioning measurements from the UE, a base station, a TRP, or an LMF. In some implementations, the means for obtaining at least one of the location of the UE or the set of positioning measurements may include configuring the apparatus 1504 to obtain at least one of the location of the UE or the set of positioning measurements using AI/ML.

In another configuration, the apparatus 1504 may further include means for determining, based on the indication of the verification of the data associated with the location of the UE or the validation of the data associated with the location of the UE, a set of decisions related to positioning of the UE.

In another configuration, the apparatus 1504 may further include means for transmitting, based on reception of the indication, a message indicating a validity for at least one of: the location of the UE, a set of positioning measurements used for an estimation of the location of the UE, a positioning method used for the estimation of the location of the UE, a measurement method used for obtaining the set of positioning measurements, or an AI/ML model or functionality used for an obtainment of the location of the UE or the set of positioning measurements.

In another configuration, the apparatus 1504 may further include means for transmitting or means for receiving a set of capabilities or supports related to the set of DTs or the NDT for the positioning operation.

The means may be the digital twin request component 198 of the apparatus 1504 configured to perform the functions recited by the means. As described supra, the apparatus 1504 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 16 is a diagram 1600 illustrating an example of a hardware implementation for a network entity 1602. The network entity 1602 may be a BS, a component of a BS, or may implement BS functionality. The network entity 1602 may include at least one of a CU 1610, a DU 1630, or an RU 1640. For example, depending on the layer functionality handled by the digital twin request component 199, the network entity 1602 may include the CU 1610; both the CU 1610 and the DU 1630; each of the CU 1610, the DU 1630, and the RU 1640; the DU 1630; both the DU 1630 and the RU 1640; or the RU 1640. The CU 1610 may include at least one CU processor 1612. The CU processor(s) 1612 may include on-chip memory 1612′. In some aspects, the CU 1610 may further include additional memory modules 1614 and a communications interface 1618. The CU 1610 communicates with the DU 1630 through a midhaul link, such as an F1 interface. The DU 1630 may include at least one DU processor 1632. The DU processor(s) 1632 may include on-chip memory 1632′. In some aspects, the DU 1630 may further include additional memory modules 1634 and a communications interface 1638. The DU 1630 communicates with the RU 1640 through a fronthaul link. The RU 1640 may include at least one RU processor 1642. The RU processor(s) 1642 may include on-chip memory 1642′. In some aspects, the RU 1640 may further include additional memory modules 1644, one or more transceivers 1646, antennas 1680, and a communications interface 1648. The RU 1640 communicates with the UE 104. The on-chip memory 1612′, 1632′, 1642′ and the additional memory modules 1614, 1634, 1644 may each be considered a computer-readable medium/memory. Each computer-readable medium/memory may be non-transitory. Each of the processors 1612, 1632, 1642 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the digital twin request component 199 may be configured to transmit, to a DT provider, a first request for a creation of a set of DTs or an NDT or for an activation of the set of DTs or the NDT for a positioning operation associated with at least one DT consumer. The digital twin request component 199 may also be configured to transmit, to the DT provider based on the creation of the set of DTs or the NDT or the activation of the set of DTs or the NDT, a second request to verify data associated with a location of a UE or to validate the data associated with the location of the UE. The digital twin request component 199 may also be configured to receive, from the DT provider based on the second request, an indication of a verification of the data associated with the location of the UE or a validation of the data associated with the location of the UE. The digital twin request component 199 may be within one or more processors of one or more of the CU 1610, DU 1630, and the RU 1640. The digital twin request component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1602 may include a variety of components configured for various functions. In one configuration, the network entity 1602 may include means for transmitting, to a DT provider, a first request for a creation of a set of DTs or an NDT or for an activation of the set of DTs or the NDT for a positioning operation associated with at least one DT consumer. The network entity 1602 may further include means for transmitting, to the DT provider based on the creation of the set of DTs or the NDT or the activation of the set of DTs or the NDT, a second request to verify data associated with a location of a UE or to validate the data associated with the location of the UE. The network entity 1602 may further include means for receiving, from the DT provider based on the second request, an indication of a verification of the data associated with the location of the UE or a validation of the data associated with the location of the UE.

In one configuration, the indication of the verification of the data associated with the location of the UE includes at least one of: (1) a set of simulated positioning measurements derived from the location of the UE, (2) a difference between a set of positioning measurements used for an estimation of the location of the UE and the set of simulated positioning measurements, (3) a validity of the set of positioning measurements used for the estimation of the location of the UE, or (4) a simulated location of the UE derived from the set of positioning measurements used for the estimation of the location of the UE. In some implementations, the DT consumer may forward at least one of: (1) the set of simulated positioning measurements, (2) the difference between the set of positioning measurements and the set of simulated positioning measurements, (3) the validity of the set of positioning measurements, or (4) the simulated location of the UE.

In another configuration, the verification of the data associated with the location of the UE includes a positive verification or a negative verification.

In another configuration, the network entity 1602 may further include means for receiving, from the DT provider based on the first request, a notification or a confirmation for the creation of the set of DTs or the NDT or the activation of the set of DTs or the NDT for the positioning operation associated with the at least one DT consumer, where transmission of the second request is based on reception of the notification or the confirmation. In some implementations, the first request includes a set of simulation or emulation specifications, and reception of the notification or the confirmation for the creation of the set of DTs or the NDT or the activation of the set of DTs or the NDT is based on the set of simulation or emulation specifications being able to be satisfied by the DT provider. In some implementations, the set of simulation or emulation specifications includes at least one of a designated area, a set of RS configurations, or a specified network setup.

In another configuration, the data includes at least one of the location of the UE or a set of positioning measurements used for an estimation of the location of the UE. In some implementations, the network entity 1602 may further include means for obtaining at least one of the location of the UE or the set of positioning measurements, and transmit, to the DT provider, at least one of the location of the UE or the set of positioning measurements. In some implementations, the means for obtaining at least one of the location of the UE or the set of positioning measurements may include configuring the network entity 1602 to receive at least one of the location of the UE or the set of positioning measurements from the UE, a base station, a TRP, or an LMF. In some implementations, the means for obtaining at least one of the location of the UE or the set of positioning measurements may include configuring the network entity 1602 to obtain at least one of the location of the UE or the set of positioning measurements using AI/ML.

In another configuration, the network entity 1602 may further include means for determining, based on the indication of the verification of the data associated with the location of the UE or the validation of the data associated with the location of the UE, a set of decisions related to positioning of the UE.

In another configuration, the network entity 1602 may further include means for transmitting, based on reception of the indication, a message indicating a validity for at least one of: the location of the UE, a set of positioning measurements used for an estimation of the location of the UE, a positioning method used for the estimation of the location of the UE, a measurement method used for obtaining the set of positioning measurements, or an AI/ML model or functionality used for an obtainment of the location of the UE or the set of positioning measurements.

In another configuration, the network entity 1602 may further include means for transmitting or means for receiving a set of capabilities or supports related to the set of DTs or the NDT for the positioning operation.

The means may be the digital twin request component 199 of the network entity 1602 configured to perform the functions recited by the means. As described supra, the network entity 1602 may include the TX processor 316, the RX processor 370, and the controller/processor 375. As such, in one configuration, the means may be the TX processor 316, the RX processor 370, and/or the controller/processor 375 configured to perform the functions recited by the means.

FIG. 17 is a diagram 1700 illustrating an example of a hardware implementation for a network entity 1760. In one example, the network entity 1760 may be within the core network 120. The network entity 1760 may include at least one network processor 1712. The network processor(s) 1712 may include on-chip memory 1712′. In some aspects, the network entity 1760 may further include additional memory modules 1714. The network entity 1760 communicates via the network interface 1780 directly (e.g., backhaul link) or indirectly (e.g., through a RIC) with the CU 1702. The on-chip memory 1712′ and the additional memory modules 1714 may each be considered a computer-readable medium/memory. Each computer-readable medium/memory may be non-transitory. The network processor(s) 1712 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the digital twin request component 197 may be configured to transmit, to a DT provider, a first request for a creation of a set of DTs or an NDT or for an activation of the set of DTs or the NDT for a positioning operation associated with at least one DT consumer. The digital twin request component 197 may also be configured to transmit, to the DT provider based on the creation of the set of DTs or the NDT or the activation of the set of DTs or the NDT, a second request to verify data associated with a location of a UE or to validate the data associated with the location of the UE. The digital twin request component 197 may also be configured to receive, from the DT provider based on the second request, an indication of a verification of the data associated with the location of the UE or a validation of the data associated with the location of the UE. The digital twin request component 197 may be within the network processor(s) 1712. The digital twin request component 197 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1760 may include a variety of components configured for various functions. In one configuration, the network entity 1760 may include means for transmitting, to a DT provider, a first request for a creation of a set of DTs or an NDT or for an activation of the set of DTs or the NDT for a positioning operation associated with at least one DT consumer. The network entity 1760 may further include means for transmitting, to the DT provider based on the creation of the set of DTs or the NDT or the activation of the set of DTs or the NDT, a second request to verify data associated with a location of a UE or to validate the data associated with the location of the UE. The network entity 1760 may further include means for receiving, from the DT provider based on the second request, an indication of a verification of the data associated with the location of the UE or a validation of the data associated with the location of the UE.

In one configuration, the indication of the verification of the data associated with the location of the UE includes at least one of: (1) a set of simulated positioning measurements derived from the location of the UE, (2) a difference between a set of positioning measurements used for an estimation of the location of the UE and the set of simulated positioning measurements, (3) a validity of the set of positioning measurements used for the estimation of the location of the UE, or (4) a simulated location of the UE derived from the set of positioning measurements used for the estimation of the location of the UE. In some implementations, the DT consumer may forward at least one of: (1) the set of simulated positioning measurements, (2) the difference between the set of positioning measurements and the set of simulated positioning measurements, (3) the validity of the set of positioning measurements, or (4) the simulated location of the UE.

In another configuration, the verification of the data associated with the location of the UE includes a positive verification or a negative verification.

In another configuration, the network entity 1760 may further include means for receiving, from the DT provider based on the first request, a notification or a confirmation for the creation of the set of DTs or the NDT or the activation of the set of DTs or the NDT for the positioning operation associated with the at least one DT consumer, where transmission of the second request is based on reception of the notification or the confirmation. In some implementations, the first request includes a set of simulation or emulation specifications, and reception of the notification or the confirmation for the creation of the set of DTs or the NDT or the activation of the set of DTs or the NDT is based on the set of simulation or emulation specifications being able to be satisfied by the DT provider. In some implementations, the set of simulation or emulation specifications includes at least one of a designated area, a set of RS configurations, or a specified network setup.

In another configuration, the data includes at least one of the location of the UE or a set of positioning measurements used for an estimation of the location of the UE. In some implementations, the network entity 1760 may further include means for obtaining at least one of the location of the UE or the set of positioning measurements, and transmit, to the DT provider, at least one of the location of the UE or the set of positioning measurements. In some implementations, the means for obtaining at least one of the location of the UE or the set of positioning measurements may include configuring the network entity 1760 to receive at least one of the location of the UE or the set of positioning measurements from the UE, a base station, a TRP, or an LMF. In some implementations, the means for obtaining at least one of the location of the UE or the set of positioning measurements may include configuring the network entity 1760 to obtain at least one of the location of the UE or the set of positioning measurements using AI/ML.

In another configuration, the network entity 1760 may further include means for determining, based on the indication of the verification of the data associated with the location of the UE or the validation of the data associated with the location of the UE, a set of decisions related to positioning of the UE.

In another configuration, the network entity 1760 may further include means for transmitting, based on reception of the indication, a message indicating a validity for at least one of: the location of the UE, a set of positioning measurements used for an estimation of the location of the UE, a positioning method used for the estimation of the location of the UE, a measurement method used for obtaining the set of positioning measurements, or an AI/ML model or functionality used for an obtainment of the location of the UE or the set of positioning measurements.

In another configuration, the network entity 1760 may further include means for transmitting or means for receiving a set of capabilities or supports related to the set of DTs or the NDT for the positioning operation.

The means may be the digital twin request component 197 of the network entity 1760 configured to perform the functions recited by the means.

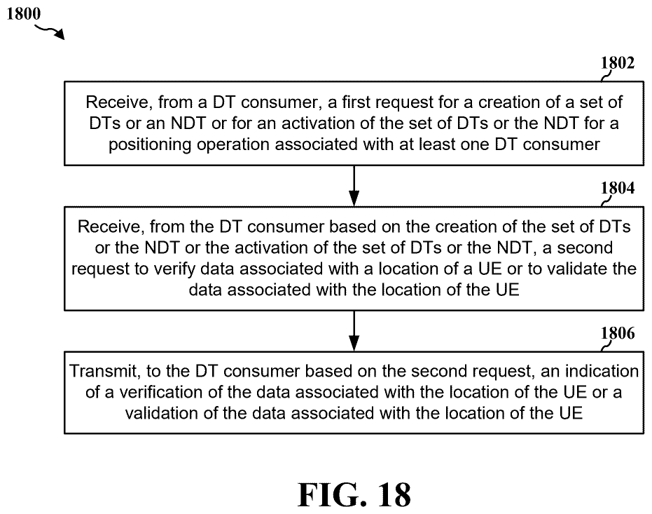

FIG. 18 is a flowchart 1800 of wireless communication. The method may be performed by a DT provider (e.g., the DT provider 1204; the network entity 1960). The method may enable the DT provider to verify or validate, for a DT consumer (e.g., a UE, a base station/TRP, a location server, an LMF, etc.), the location of the UE or a set of positioning measurement associated with deriving the location of the UE based on using a set of DTs or an NDT, thereby improving the overall performance of the positioning.

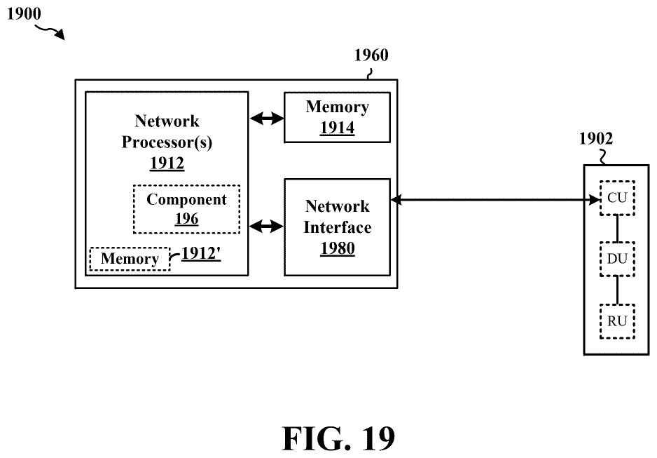

At 1802, the DT provider may receive, from a DT consumer, a first request for a creation of a set of DTs or an NDT or for an activation of the set of DTs or the NDT for a positioning operation associated with at least one DT consumer, such as described in connection with FIG. 12. For example, at 1220, a DT provider 1204 may receive, from a DT consumer 1202, a request for creation/activation of DT/NDT. The reception of the first request may be performed by, e.g., the digital twin activation or creation component 196, the network processor(s) 1912, and/or the network interface 1980 of the network entity 1960 in FIG. 19.

At 1804, the DT provider may receive, from the DT consumer based on the creation of the set of DTs or the NDT or the activation of the set of DTs or the NDT, a second request to verify data associated with a location of a UE or to validate the data associated with the location of the UE, such as described in connection with FIG. 12. For example, at 1226, after the DT/NDT creation/activation, the DT provider 1204 may receive, from the DT consumer 1202, a request to verify/validate the location of a UE 1210 or a set of measurements that is associated with deriving the location of the UE 1210 (e.g., the RTOA, RSTD, LOS indicator, UE Rx-Tx-time difference, gNB Rx-Tx time difference, RSRP, RSRPP, additional path timing information, RSCP, RSCPD, etc.). The reception of the second request may be performed by, e.g., the digital twin activation or creation component 196, the network processor(s) 1912, and/or the network interface 1980 of the network entity 1960 in FIG. 19.

At 1806, the DT provider may transmit, to the DT consumer based on the second request, an indication of a verification of the data associated with the location of the UE or a validation of the data associated with the location of the UE, such as described in connection with FIG. 12. For example, at 1238, based on the determination at 1234, the DT provider 1204 may report the verification/validation results of the location and/or the positioning measurements of the UE 1210. The transmission of the indication may be performed by, e.g., the digital twin activation or creation component 196, the network processor(s) 1912, and/or the network interface 1980 of the network entity 1960 in FIG. 19.

In one example, the DT provider may transmit, to the DT consumer based on the first request, a notification of the set of DTs or the NDT or a confirmation for the creation of the set of DTs or the NDT or the activation of the set of DTs or the NDT for the positioning operation associated with the at least one DT consumer, where transmission of the second request is based on reception of the notification or the confirmation. In some implementations, the first request includes a set of simulation or emulation specifications, and the DT provider may be configured to determine whether the DT provider is capable of satisfying the set of simulation or emulation specifications, where transmission of the notification or the confirmation for the creation of the set of DTs or the NDT or the activation of the set of DTs or the NDT is based on the DT provider being capable of satisfying the set of simulation or emulation specifications. In some implementations, the set of simulation or emulation specifications includes at least one of a designated area, a set of RS configurations, or a specified network setup, where reception of the notification or the confirmation is based on the set of simulation or emulation specifications being able to be satisfied by the DT consumer.

In another example, the data includes at least one of the location of the UE or a set of positioning measurements used for an estimation of the location of the UE. In some implementations, the DT provider may receive, from the DT consumer, at least one of the location of the UE or the set of positioning measurements. In some implementations, the location of the UE or the set of positioning measurements is based on AI/ML.

In another example, the indication of the verification of the data associated with the location of the UE includes at least one of: (1) a set of simulated positioning measurements derived from the location of the UE, (2) a difference between a set of positioning measurements used for an estimation of the location of the UE and the set of simulated positioning measurements, (3) a validity of the set of positioning measurements used for the estimation of the location of the UE, or (4) a simulated location of the UE derived from the set of positioning measurements used for the estimation of the location of the UE.

In another example, the DT provider may perform a set of simulations or a set of emulations based on the data associated with the location of the UE. In some implementations, to perform the set of simulations, the DT provider may be configured to perform the set of simulations via ray tracing (RT), and to perform the set of emulations, the DT provider may be configured to perform the set of emulations via configuring a set of virtualized equipments to conduct a set of RAN related operations. In some implementations, the DT provider may verify, based on the set of simulations or the set of emulations, the data associated with the location of the UE.

In another example, the verification of the data associated with the location of the UE includes a positive verification or a negative verification.

In another example, the DT consumer corresponds to the UE, a base station, a TRP, an LMF, an NWDAF, an AI/ML management function, or a sensing management function, a network function, an OAM entity, an ORAN entity, or an OTT server.

In another example, the DT provider corresponds to a second UE, a base station, a TRP, an LMF, an NWDAF, an AI/ML management function, a sensing management function, a network function, an OAM entity, an ORAN entity, or an OTT server.

In another example, the DT provider may transmit or receive a set of capabilities or supports related to the set of DTs or the NDT for the positioning operation.

FIG. 19 is a diagram 1900 illustrating an example of a hardware implementation for a network entity 1960. In one example, the network entity 1960 may be within the core network 120. The network entity 1960 may include at least one network processor 1912. The network processor(s) 1912 may include on-chip memory 1912′. In some aspects, the network entity 1960 may further include additional memory modules 1914. The network entity 1960 communicates via the network interface 1980 directly (e.g., backhaul link) or indirectly (e.g., through a RIC) with the CU 1902. The on-chip memory 1912′ and the additional memory modules 1914 may each be considered a computer-readable medium/memory. Each computer-readable medium/memory may be non-transitory. The network processor(s) 1912 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the digital twin activation or creation component 196 may be configured to receive, from a DT consumer, a first request for a creation of a set of DTs or an NDT or for an activation of the set of DTs or the NDT for a positioning operation associated with at least one DT consumer. The digital twin activation or creation component 196 may also be configured to receive, from the DT consumer based on the creation of the set of DTs or the NDT or the activation of the set of DTs or the NDT, a second request to verify data associated with a location of a UE or to validate the data associated with the location of the UE. The digital twin activation or creation component 196 may also be configured to transmit, to the DT consumer based on the second request, an indication of a verification of the data associated with the location of the UE or a validation of the data associated with the location of the UE. The digital twin activation or creation component 196 may be within the network processor(s) 1912. The digital twin activation or creation component 196 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1960 may include a variety of components configured for various functions. In one configuration, the network entity 1960 may include means for receiving, from a DT consumer, a first request for a creation of a set of DTs or an NDT or for an activation of the set of DTs or the NDT for a positioning operation associated with at least one DT consumer. The network entity 1960 may further include means for receiving, from the DT consumer based on the creation of the set of DTs or the NDT or the activation of the set of DTs or the NDT, a second request to verify data associated with a location of a UE or to validate the data associated with the location of the UE. The network entity 1960 may further include means for transmitting, to the DT consumer based on the second request, an indication of a verification of the data associated with the location of the UE or a validation of the data associated with the location of the UE.

In one configuration, the network entity 1960 may further include means for transmitting, to the DT consumer based on the first request, a notification of the set of DTs or the NDT or a confirmation for the creation of the set of DTs or the NDT or the activation of the set of DTs or the NDT for the positioning operation associated with the at least one DT consumer, where transmission of the second request is based on reception of the notification or the confirmation. In some implementations, the first request includes a set of simulation or emulation specifications, and the DT provider may be configured to determine whether the DT provider is capable of satisfying the set of simulation or emulation specifications, where transmission of the notification or the confirmation for the creation of the set of DTs or the NDT or the activation of the set of DTs or the NDT is based on the DT provider being capable of satisfying the set of simulation or emulation specifications. In some implementations, the set of simulation or emulation specifications includes at least one of a designated area, a set of RS configurations, or a specified network setup, where reception of the notification or the confirmation is based on the set of simulation or emulation specifications being able to be satisfied by the DT consumer.

In another configuration, the data includes at least one of the location of the UE or a set of positioning measurements used for an estimation of the location of the UE. In some implementations, the network entity 1960 may further include means for receiving, from the DT consumer, at least one of the location of the UE or the set of positioning measurements. In some implementations, the location of the UE or the set of positioning measurements is based on AI/ML.

In another configuration, the indication of the verification of the data associated with the location of the UE includes at least one of: (1) a set of simulated positioning measurements derived from the location of the UE, (2) a difference between a set of positioning measurements used for an estimation of the location of the UE and the set of simulated positioning measurements, (3) a validity of the set of positioning measurements used for the estimation of the location of the UE, or (4) a simulated location of the UE derived from the set of positioning measurements used for the estimation of the location of the UE.

In another configuration, the network entity 1960 may further include means for performing a set of simulations or a set of emulations based on the data associated with the location of the UE. In some implementations, the means for performing the set of simulations may include configuring the network entity 1960 to perform the set of simulations via RT, and means for performing the set of emulations may include configuring the network entity 1960 to perform the set of emulations via configuring a set of virtualized equipments to conduct a set of RAN related operations. In some implementations, the network entity 1960 may further include means for verifying, based on the set of simulations or the set of emulations, the data associated with the location of the UE.

In another configuration, the verification of the data associated with the location of the UE includes a positive verification or a negative verification.

In another configuration, the DT consumer corresponds to the UE, a base station, a TRP, an LMF, an NWDAF, an AI/ML management function, or a sensing management function, a network function, an OAM entity, an ORAN entity, or an OTT server.

In another configuration, the network entity 1960 may further include means for transmitting or means for receiving a set of capabilities or supports related to the set of DTs or the NDT for the positioning operation.

In another configuration, the DT provider corresponds to a second UE, a base station, a TRP, an LMF, an NWDAF, an AI/ML management function, a sensing management function, a network function, an OAM entity, an ORAN entity, or an OTT server.

The means may be the digital twin activation or creation component 196 of the network entity 1960 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processors P) is configured to perform a set of functions F, each processor of P may be configured to perform a subset S of F, where S & F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a digital twin (DT) consumer, comprising: transmitting, to a DT provider, a first request for a creation of a set of DTs or a network digital twin (NDT) or for an activation of the set of DTs or the NDT for a positioning operation associated with at least one DT consumer; transmitting, to the DT provider based on the creation of the set of DTs or the NDT or the activation of the set of DTs or the NDT, a second request to verify data associated with a location of a user equipment (UE) or to validate the data associated with the location of the UE; and receiving, from the DT provider based on the second request, an indication of a verification of the data associated with the location of the UE or a validation of the data associated with the location of the UE.

Aspect 2 is the method of aspect 1, further comprising: receiving, from the DT provider based on the first request, a notification or a confirmation for the creation of the set of DTs or the NDT or the activation of the set of DTs or the NDT for the positioning operation associated with the at least one DT consumer, wherein transmission of the second request is based on reception of the notification or the confirmation.

Aspect 3 is the method of aspect 1 or aspect 2, wherein the first request includes a set of simulation or emulation specifications, wherein reception of the notification or the confirmation for the creation of the set of DTs or the NDT or the activation of the set of DTs or the NDT is based on the set of simulation or emulation specifications being able to be satisfied by the DT provider.

Aspect 4 is the method of any of aspects 1 to 3, wherein the set of simulation or emulation specifications includes at least one of a designated area, a set of reference signal (RS) configurations, or a specified network setup.

Aspect 5 is the method of any of aspects 1 to 4, wherein the data includes at least one of the location of the UE or a set of positioning measurements used for an estimation of the location of the UE.

Aspect 6 is the method of any of aspects 1 to 5, further comprising: obtaining at least one of the location of the UE or the set of positioning measurements; and transmitting, to the DT provider, at least one of the location of the UE or the set of positioning measurements.

Aspect 7 is the method of any of aspects 1 to 6, wherein obtaining at least one of the location of the UE or the set of positioning measurements comprises: receiving at least one of the location of the UE or the set of positioning measurements from the UE, a base station, a transmission reception point (TRP), or a location management function (LMF).

Aspect 8 is the method of any of aspects 1 to 7, wherein obtaining at least one of the location of the UE or the set of positioning measurements comprises: obtaining at least one of the location of the UE or the set of positioning measurements using artificial intelligence (AI) or machine learning (ML) (AI/ML).

Aspect 9 is the method of any of aspects 1 to 8, wherein the indication of the verification of the data associated with the location of the UE includes at least one of: (1) a set of simulated positioning measurements derived from the location of the UE, (2) a difference between a set of positioning measurements used for an estimation of the location of the UE and the set of simulated positioning measurements, (3) a validity of the set of positioning measurements used for the estimation of the location of the UE, or (4) a simulated location of the UE derived from the set of positioning measurements used for the estimation of the location of the UE.

Aspect 10 is the method of any of aspects 1 to 9, further comprising: forwarding at least one of: (1) the set of simulated positioning measurements, (2) the difference between the set of positioning measurements and the set of simulated positioning measurements, (3) the validity of the set of positioning measurements, or (4) the simulated location of the UE.

Aspect 11 is the method of any of aspects 1 to 10, further comprising: determining, based on the indication of the verification of the data associated with the location of the UE or the validation of the data associated with the location of the UE, a set of decisions related to positioning of the UE.

Aspect 12 is the method of any of aspects 1 to 11, further comprising: transmitting, based on reception of the indication, a message indicating a validity for at least one of: the location of the UE, a set of positioning measurements used for an estimation of the location of the UE, a positioning method used for the estimation of the location of the UE, a measurement method used for obtaining the set of positioning measurements, or an artificial intelligence (AI) or machine learning (ML) (AI/ML) model or functionality used for an obtainment of the location of the UE or the set of positioning measurements.

Aspect 13 is the method of any of aspects 1 to 12, wherein the verification of the data associated with the location of the UE includes a positive verification or a negative verification.

Aspect 14 is the method of any of aspects 1 to 13, wherein the DT consumer corresponds to the UE, a base station, a transmission reception point (TRP), a location management function (LMF), a network data analytics function (NWDAF), an AI/ML management function, or a sensing management function, a network function, an operations and management (OAM) entity, an open radio access network (ORAN) entity, or an over-the-top (OTT) server, and wherein the DT provider corresponds to a second UE, a base station, a TRP, an LMF, an NWDAF, an AI/ML management function, a sensing management function, a network function, an OAM entity, an ORAN entity, or an OTT server.

Aspect 15 is the method of any of aspects 1 to 14, further comprising: transmitting or receiving a set of capabilities or supports related to the set of DTs or the NDT for the positioning operation.

Aspect 16 is an apparatus for wireless communication at a digital twin (DT) consumer, including: at least one memory; and at least one processor coupled to the at least one memory and, based at least in part on stored information that is stored in the at least one memory, the at least one processor, individually or in any combination, is configured to implement any of aspects 1 to 15.

Aspect 17 is the apparatus of aspect 16, further including at least one transceiver or at least one network interface coupled to the at least one processor.

Aspect 18 is an apparatus for wireless communication at a digital twin (DT) consumer including means for implementing any of aspects 1 to 15.

Aspect 19 is a computer-readable medium (e.g., a non-transitory computer-readable medium) storing computer executable code, where the code when executed by a processor causes the processor to implement any of aspects 1 to 15.

Aspect 20 is a method of wireless communication at a digital twin (DT) provider, comprising: receiving, from a DT consumer, a first request for a creation of a set of DTs or a network digital twin (NDT) or for an activation of the set of DTs or the NDT for a positioning operation associated with at least one DT consumer; receiving, from the DT consumer based on the creation of the set of DTs or the NDT or the activation of the set of DTs or the NDT, a second request to verify data associated with a location of a user equipment (UE) or to validate the data associated with the location of the UE; and transmitting, to the DT consumer based on the second request, an indication of a verification of the data associated with the location of the UE or a validation of the data associated with the location of the U.

Aspect 21 is the method of aspect 20, further comprising: transmitting, to the DT consumer based on the first request, a notification or a confirmation for the creation of the set of DTs or the NDT or the activation of the set of DTs or the NDT for the positioning operation associated with the at least one DT consumer, where transmission of the second request is based on reception of the notification or the confirmation.

Aspect 22 is the method of aspect 20 or aspect 21, wherein the first request includes a set of simulation or emulation specifications, the method further comprises: determining whether the DT provider is capable of satisfying the set of simulation or emulation specifications, wherein transmission of the notification or the confirmation for the creation of the set of DTs or the NDT or the activation of the set of DTs or the NDT is based on the DT provider being capable of satisfying the set of simulation or emulation specifications.

Aspect 23 is the method of any of aspects 20 to 22, wherein the set of simulation or emulation specifications includes at least one of a designated area, a set of reference signal (RS) configurations, or a specified network setup, wherein reception of the notification or the confirmation is based on the set of simulation or emulation specifications being able to be satisfied by the DT consumer.

Aspect 24 is the method of any of aspects 20 to 23, wherein the data includes at least one of the location of the UE or a set of positioning measurements used for an estimation of the location of the UE.

Aspect 25 is the method of any of aspects 20 to 24, further comprising: receiving, from the DT consumer, at least one of the location of the UE or the set of positioning measurements.

Aspect 26 is the method of any of aspects 20 to 25, wherein the location of the UE or the set of positioning measurements is based on artificial intelligence (AI) or machine learning (ML) (AI/ML).

Aspect 27 is the method of any of aspects 20 to 26, wherein the indication of the verification of the data associated with the location of the UE includes at least one of: (1) a set of simulated positioning measurements derived from the location of the UE, (2) a difference between a set of positioning measurements used for an estimation of the location of the UE and the set of simulated positioning measurements, (3) a validity of the set of positioning measurements used for the estimation of the location of the UE, or (4) a simulated location of the UE derived from the set of positioning measurements used for the estimation of the location of the UE.

Aspect 28 is the method of any of aspects 20 to 27, further comprising: performing a set of simulations or a set of emulations based on the data associated with the location of the UE.

Aspect 29 is the method of any of aspects 20 to 28, wherein performing the set of simulations comprises performing the set of simulations via ray tracing (RT), and wherein performing the set of emulations comprises performing the set of emulations via configuring a set of virtualized equipments to conduct a set of radio access network (RAN) related operations.

Aspect 30 is the method of any of aspects 20 to 29, further comprising: verifying, based on the set of simulations or the set of emulations, the data associated with the location of the UE.

Aspect 31 is the method of any of aspects 20 to 30, wherein the verification of the data associated with the location of the UE includes a positive verification or a negative verification.

Aspect 32 is the method of any of aspects 20 to 31, wherein the DT consumer corresponds to the UE, a base station, a transmission reception point (TRP), a location management function (LMF), a network data analytics function (NWDAF), an AI/ML management function, or a sensing management function, a network function, an operations and management (OAM) entity, an open radio access network (ORAN) entity, or an over-the-top (OTT) server, and wherein the DT provider corresponds to a second UE, a base station, a TRP, an LMF, an NWDAF, an AI/ML management function, a sensing management function, a network function, an OAM entity, an ORAN entity, or an OTT server.

Aspect 33 is the method of any of aspects 20 to 32, further comprising: transmitting or receiving a set of capabilities or supports related to the set of DTs or the NDT for the positioning operation.

Aspect 34 is an apparatus for wireless communication at a digital twin (DT) provider, including: at least one memory; and at least one processor coupled to the at least one memory and, based at least in part on stored information that is stored in the at least one memory, the at least one processor, individually or in any combination, is configured to implement any of aspects 20 to 33.

Aspect 35 is the apparatus of aspect 34, further including at least one network interface coupled to the at least one processor.

Aspect 36 is an apparatus for wireless communication at a digital twin (DT) provider including means for implementing any of aspects 20 to 33.

Aspect 37 is a computer-readable medium (e.g., a non-transitory computer-readable medium) storing computer executable code, where the code when executed by a processor causes the processor to implement any of aspects 20 to 33.

What is claimed is:

1. An apparatus for wireless communication at a digital twin (DT) consumer, comprising:
at least one memory; and
at least one processor coupled to the at least one memory, wherein the at least one processor is configured to:
transmit, to a DT provider, a first request for a creation of a set of DTs or a network digital twin (NDT) or for an activation of the set of DTs or the NDT for a positioning operation associated with at least one DT consumer;
transmit, to the DT provider based on the creation of the set of DTs or the NDT or the activation of the set of DTs or the NDT, a second request to verify data associated with a location of a user equipment (UE) or to validate the data associated with the location of the UE; and
receive, from the DT provider based on the second request, an indication of a verification of the data associated with the location of the UE or a validation of the data associated with the location of the UE.

2. The apparatus of claim 1, wherein the at least one processor is further configured to:
receive, from the DT provider based on the first request, a notification or a confirmation for the creation of the set of DTs or the NDT or the activation of the set of DTs or the NDT for the positioning operation associated with the at least one DT consumer, wherein transmission of the second request is based on reception of the notification or the confirmation.

3. The apparatus of claim 2, wherein the first request includes a set of simulation or emulation specifications, wherein reception of the notification or the confirmation for the creation of the set of DTs or the NDT or the activation of the set of DTs or the NDT is based on the set of simulation or emulation specifications being able to be satisfied by the DT provider.

4. The apparatus of claim 3, wherein the set of simulation or emulation specifications includes at least one of a designated area, a set of reference signal (RS) configurations, or a specified network setup.

5. The apparatus of claim 1, wherein the data includes at least one of the location of the UE or a set of positioning measurements used for an estimation of the location of the UE.

6. The apparatus of claim 5, wherein the at least one processor is further configured to:
obtain at least one of the location of the UE or the set of positioning measurements; and
transmit, to the DT provider, at least one of the location of the UE or the set of positioning measurements.

7. The apparatus of claim 6, wherein to obtain at least one of the location of the UE or the set of positioning measurements, the at least one processor is configured to:
receive at least one of the location of the UE or the set of positioning measurements from the UE, a base station, a transmission reception point (TRP), or a location management function (LMF).

8. The apparatus of claim 5, wherein to obtain at least one of the location of the UE or the set of positioning measurements comprises, the at least one processor is configured to:
obtain at least one of the location of the UE or the set of positioning measurements using artificial intelligence (AI) or machine learning (ML) (AI/ML).

9. The apparatus of claim 1, wherein the indication of the verification of the data associated with the location of the UE includes at least one of: (1) a set of simulated positioning measurements derived from the location of the UE, (2) a difference between a set of positioning measurements used for an estimation of the location of the UE and the set of simulated positioning measurements, (3) a validity of the set of positioning measurements used for the estimation of the location of the UE, or (4) a simulated location of the UE derived from the set of positioning measurements used for the estimation of the location of the UE.

10. The apparatus of claim 9, wherein the at least one processor is further configured to:
forward at least one of: (1) the set of simulated positioning measurements, (2) the difference between the set of positioning measurements and the set of simulated positioning measurements, (3) the validity of the set of positioning measurements, or (4) the simulated location of the UE.

11. The apparatus of claim 1, wherein the at least one processor is further configured to:
determine, based on the indication of the verification of the data associated with the location of the UE or the validation of the data associated with the location of the UE, a set of decisions related to positioning of the UE.

12. The apparatus of claim 1, wherein the at least one processor is further configured to:
transmit, based on reception of the indication, a message indicating a validity for at least one of:
the location of the UE,
a set of positioning measurements used for an estimation of the location of the UE,
a positioning apparatus used for the estimation of the location of the UE, a measurement apparatus used for obtaining the set of positioning measurements, or
an artificial intelligence (AI) or machine learning (ML) (AI/ML) model or functionality used for an obtainment of the location of the UE or the set of positioning measurements.

13. The apparatus of claim 1, wherein the at least one processor is further configured to:
transmit or receive a set of capabilities or supports related to the set of DTs or the NDT for the positioning operation.

14. The apparatus of claim 1, wherein the DT consumer corresponds to the UE, a base station, a transmission reception point (TRP), a location management function (LMF), a network data analytics function (NWDAF), an AI/ML management function, or a sensing management function, a network function, an operations and management (OAM) entity, an open radio access network (ORAN) entity, or an over-the-top (OTT) server.

15. A method of wireless communication at a digital twin (DT) consumer, comprising:
transmitting, to a DT provider, a first request for a creation of a set of DTs or a network digital twin (NDT) or for an activation of the set of DTs or the NDT for a positioning operation associated with at least one DT consumer;
transmitting, to the DT provider based on the creation of the set of DTs or the NDT or the activation of the set of DTs or the NDT, a second request to verify data associated with a location of a user equipment (UE) or to validate the data associated with the location of the UE; and
receiving, from the DT provider based on the second request, an indication of a verification of the data associated with the location of the UE or a validation of the data associated with the location of the UE.

16. The method of claim 15, further comprising:
determining, based on the indication of the verification of the data associated with the location of the UE or the validation of the data associated with the location of the UE, a set of decisions related to positioning of the UE.

17. An apparatus for wireless communication at a digital twin (DT) provider, comprising:
at least one memory; and
at least one processor coupled to the at least one memory, wherein the at least one processor is configured to:
receive, from a DT consumer, a first request for a creation of a set of DTs or a network digital twin (NDT) or for an activation of the set of DTs or the NDT for a positioning operation associated with at least one DT consumer;
receive, from the DT consumer based on the creation of the set of DTs or the NDT or the activation of the set of DTs or the NDT, a second request to verify data associated with a location of a user equipment (UE) or to validate the data associated with the location of the UE; and
transmit, to the DT consumer based on the second request, an indication of a verification of the data associated with the location of the UE or a validation of the data associated with the location of the UE.

18. The apparatus of claim 17, wherein the at least one processor is further configured to:
transmit, to the DT consumer based on the first request, a notification or a confirmation for the creation of the set of DTs or the NDT or the activation of the set of DTs or the NDT for the positioning operation associated with the at least one DT consumer, where transmission of the second request is based on reception of the notification or the confirmation.

19. The apparatus of claim 18, wherein the first request includes a set of simulation or emulation specifications, the at least one processor is further configured to:
determine whether the DT provider is capable of satisfying the set of simulation or emulation specifications, wherein transmission of the notification or the confirmation for the creation of the set of DTs or the NDT or the activation of the set of DTs or the NDT is based on the DT provider being capable of satisfying the set of simulation or emulation specifications.

20. The apparatus of claim 19, wherein the set of simulation or emulation specifications includes at least one of a designated area, a set of reference signal (RS) configurations, or a specified network setup, wherein reception of the notification or the confirmation is based on the set of simulation or emulation specifications being able to be satisfied by the DT consumer.

21. The apparatus of claim 17, wherein the data includes at least one of the location of the UE or a set of positioning measurements used for an estimation of the location of the UE.

22. The apparatus of claim 21, wherein the at least one processor is further configured to:
receive, from the DT consumer, at least one of the location of the UE or the set of positioning measurements.

23. The apparatus of claim 21, wherein the location of the UE or the set of positioning measurements is based on artificial intelligence (AI) or machine learning (ML) (AI/ML).

24. The apparatus of claim 17, wherein the indication of the verification of the data associated with the location of the UE includes at least one of: (1) a set of simulated positioning measurements derived from the location of the UE, (2) a difference between a set of positioning measurements used for an estimation of the location of the UE and the set of simulated positioning measurements, (3) a validity of the set of positioning measurements used for the estimation of the location of the UE, or (4) a simulated location of the UE derived from the set of positioning measurements used for the estimation of the location of the UE.

25. The apparatus of claim 17, wherein the at least one processor is further configured to:
perform a set of simulations or a set of emulations based on the data associated with the location of the UE.

26. The apparatus of claim 25, wherein to perform the set of simulations, the at least one processor is configured to perform the set of simulations via ray tracing (RT), and to perform the set of emulations, the at least one processor is configured to perform the set of emulations via configuring a set of virtualized equipments to conduct a set of radio access network (RAN) related operations.

27. The apparatus of claim 25, wherein the at least one processor is further configured to:
verify, based on the set of simulations or the set of emulations, the data associated with the location of the UE.

28. The apparatus of claim 17, wherein further comprising:
transmitting or receiving a set of capabilities or supports related to the set of DTs or the NDT for the positioning operation.

29. The apparatus of claim 17, wherein the DT provider corresponds to a second UE, a base station, a transmission reception point (TRP), a location management function (LMF), a network data analytics function (NWDAF), an AI/ML management function, or a sensing management function, a network function, an operations and management (OAM) entity, an open radio access network (ORAN) entity, or an over-the-top (OTT) server.

30. A method of wireless communication at a digital twin (DT) provider, comprising:
receiving, from a DT consumer, a first request for a creation of a set of DTs or a network digital twin (NDT) or for an activation of the set of DTs or the NDT for a positioning operation associated with at least one DT consumer;
receiving, from the DT consumer based on the creation of the set of DTs or the NDT or the activation of the set of DTs or the NDT, a second request to verify data associated with a location of a user equipment (UE) or to validate the data associated with the location of the UE; and
transmitting, to the DT consumer based on the second request, an indication of a verification of the data associated with the location of the UE or a validation of the data associated with the location of the UE.
